(19) United States
(12) Patent Application Publication
(10) Pub. No.: US 2021/0096715 A1
(43) Pub. Date: Apr. 1, 2021

(54) DRAG AND DROP OPERATIONS ON A TOUCH SCREEN DISPLAY

(71) Applicant: Microsoft Technology Licensing, LLC, Redmond, WA (US)

(72) Inventors: Woo Ram LEE, Kirkland, WA (US); Scott D. SCHENONE, Seattle, WA (US); Kristine Cherie SULLIVAN, Everett, WA (US); Eduardo SONNINO, Seattle, WA (US); Joseph Harold PITT, Seattle, WA (US); Panos Costa PANAY, Redmond, WA (US); Trevor Cliff NOAH, Sherman Oaks, CA (US)

(73) Assignee: Microsoft Technology Licensing, LLC, Redmond, WA (US)

(21) Appl. No.: 16/718,070

(22) Filed: Dec. 17, 2019

Related U.S. Application Data
(60) Provisional application No. 62/909,146, filed on Oct. 1, 2019.

(51) Int. Cl. G06F 3/0486; G06F 3/0488

(52) U.S. Cl. CPC G06F 3/0486; G06F 3/04883

(57) ABSTRACT

A hinged mobile computing device may include a first touch screen and a second touch screen. A processor may recognize an engagement action on a virtual object displayed on one of the screens, lift the virtual object, move the virtual object in accordance with a recognized dragging action, and drop the virtual object at a target destination. Dropping the virtual object may insert the virtual object into an application program, share the virtual object to the application program or an operating system, open the virtual object in a new instance of an application program, or pin the virtual object to a predetermined location on one of the screens. In some embodiments, the virtual object may be flicked subsequent to the engagement action to share, open, or pin the virtual object.

### CROSS REFERENCE TO RELATED APPLICATIONS

This application claims priority to U.S. Provisional Patent Application Ser. No. 62/909,146, filed Oct. 1, 2019, the entirety of which is hereby incorporated herein by reference for all purposes.

### BACKGROUND

Modern computing devices typically include graphical user interfaces (GUIs) to facilitate human-computer interaction. These GUIs often represent application programs, operating system components, and files stored within a file system as virtual objects positioned on a virtual desktop. Drag and drop functionality is sometimes provided in such GUIs, which enables a user to use a pointer device to select a virtual object, drag (i.e., move) the virtual object to a destination location within the virtual desktop while continuing to select the virtual object, and release the selection of the virtual object to drop the virtual object in the destination location. The destination location may be an unoccupied region of the virtual desktop, or may be a region occupied by another virtual object representing a file system component (e.g., a file folder) or by virtual object representing an application program or operating system component. The drop action may result in causing the operating system to move the virtual object, copy the virtual object to the dropped location, or open the file associated with the dragged virtual object using an application program on which the virtual object was dropped, as some examples. While the basic principle of drag and drop functionality can provide the user with a convenient interaction model for human computer interactions, in practice many barriers exist to the effective implementation of drag and drop functionality in the myriad use case scenarios that arise in evolving computer systems, as discussed below.

### SUMMARY

To address the issues discussed herein, a mobile computing device is provided. The mobile computing device may be configured as a hinged mobile computing device that includes a housing having a first part and a second part coupled by a hinge. The first part may include a first touch screen and the second part may include a second touch screen, and the hinge may be configured to permit the first and second touch screens to rotate between angular orientations from a face-to-face angular orientation to a back-to-back angular orientation. The mobile computing device may further comprise a processor mounted in the housing. The processor may recognize an engagement action on a virtual object displayed by a source application program on one of the first or second touch screens, in response to the engagement action, lift the virtual object to be moved to a target destination on one of the first or second touch screens, recognize a dragging action of the virtual object, in response to the dragging action, move the virtual object in accordance with the recognized dragging action to the target destination, recognize a disengagement action, and, in response to the disengagement action, drop the virtual object at the target destination. Dropping the virtual object at the target destination may insert the virtual object into an application program, share the virtual object to the application program, share the virtual object to an operating system, open the virtual object in a new instance of the application program, or pin the virtual object to a predetermined location on one of the first or second capacitive touch screens. In some embodiments, the processor may be configured to recognize a flicking action subsequent to the engagement action, and in response to the flicking action, share the virtual object to the target application program, share the virtual object to the operating system, or open the virtual object in a new instance of an application program, depending upon the direction of the flicking action and the orientation of the first or second capacitive touch screens.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic of an example mobile computing device of the present description.

FIGS. 2A and 2B show front and back views, respectively, of the mobile computing device of FIG. 1 with the first and second capacitive touch screens arranged in an open, side-by-side orientation.

FIGS. 3A-3D show the mobile computing device of FIG. 1 with the first and second capacitive touch screens arranged in a variety of angular orientations from back-to-back to face-to-face.

FIG. 4 shows examples of potential outcomes for a virtual object that is moved via a drag and drop operation.

FIG. 5 shows example target destinations for drag and drop operations.

FIG. 6 shows an example of informational icons that may be displayed during a drag and drop operation.

FIGS. 7A and 7B show an example of a drag and drop operation.

FIG. 8 shows an example of a drag and drop operation in which a virtual object is inserted into an application program.

FIG. 9 shows a flowchart of a method for a drag and drop operation in which a virtual object is inserted into an application program, according to one implementation of the present disclosure.

FIGS. 10A and 10B show an example of a drag and drop operation in which a virtual object is shared to an operating system.

FIG. 11 shows a flowchart of a method for a drag and drop operation in which a virtual object is shared to an operating system, according to one implementation of the present disclosure.

FIGS. 12A-12B show an example of a drag and drop operation in which a virtual object is shared to an application program.

FIG. 13 shows a flowchart of a method for a drag and drop operation in which a virtual object is shared to an application program, according to one implementation of the present disclosure.

FIGS. 14A-14C show examples of drag and drop operations in which a virtual object is opened in a new instance of an application program.

FIG. 15 shows a flowchart of a method for a drag and drop operation in which a virtual object is opened in a new instance of an application program, according to one implementation of the present disclosure.

FIGS. 16A and 16B show an example of a drag and drop operation in which a virtual object is pinned to a predetermined location on a capacitive touch screen.

FIG. 17 shows a flowchart of a method for a drag and drop operation in which a virtual object is pinned to a predetermined location on a capacitive touch screen, according to one implementation of the present disclosure.

FIGS. 18A-18C show examples of drag and drop operations in which a virtual object is flicked to a target destination.

FIG. 19 shows a flowchart of a method for a drag and drop operation in which a virtual object is flicked to a target destination, according to one implementation of the present disclosure.

FIG. 20 shows an example computing system according to one implementation of the present disclosure.

### DETAILED DESCRIPTION

Several significant challenges exist to the effective implementation of drag and drop functionality in modern computing systems. For example, not every virtual object in the GUI may be eligible for dragging or dropping, and thus a user may find it challenging to understand which virtual objects may be moved via drag and drop, as well as which target destinations will accept a dropped virtual object. Some example factors that may further complicate a drag and drop operation include that the target destination may not be visible or may be obscured, movements when dragging or dropping may be imprecise, and the user input via the pointer device may fail to be registered by the operating system as a desire to initiate drag and drop. Additionally, the motions required to hold the virtual object in the drag state while simultaneously dragging it to a target destination may be physically uncomfortable for the user in some situations. Finally, drag and drop functionality is limited, and sometimes unavailable, on devices equipped exclusively with touch screen displays.

Thus, it will be appreciated that moving virtual objects in a graphical user interface is constrained by the user's ability to know which virtual objects are supported by drag and drop functionality, as well as by which target destinations will accept a dropped virtual object. Conventional computing systems may be sufficient for simple drag and drop operations that move a file from location to another within the virtual desktop or that open a file with an application, but lack support for more complicated operations, such as sharing a dragged virtual object to an operating system component or opening the file associated with the dropped virtual object with a new instance of an application program onto which it was dropped. Such operations typically require multiple steps within the operating system, which are not integrated into the drag and drop operation itself. These additional steps can be cumbersome, time-consuming, and potentially discouraging for the user if not performed correctly.

Performing drag and drop operations on mobile computing devices equipped exclusively with capacitive touch screens also may be hindered by the lack of availability of drag and drop functionality. Additionally, when a particular virtual object is not compatible with drag and drop functionality, when a target destination will not accept the dragged object, or when a target destination is obscured by another virtual object, an attempted drag and drop operation may fail, resulting in frustration and lost effort on behalf of the user. For these various reasons and others, it will be appreciated that significant barriers exist to successful and efficient implementation of drag and drop operations in certain scenarios, and opportunities exist to improve the state of drag and drop functionality in GUIs of computer systems.

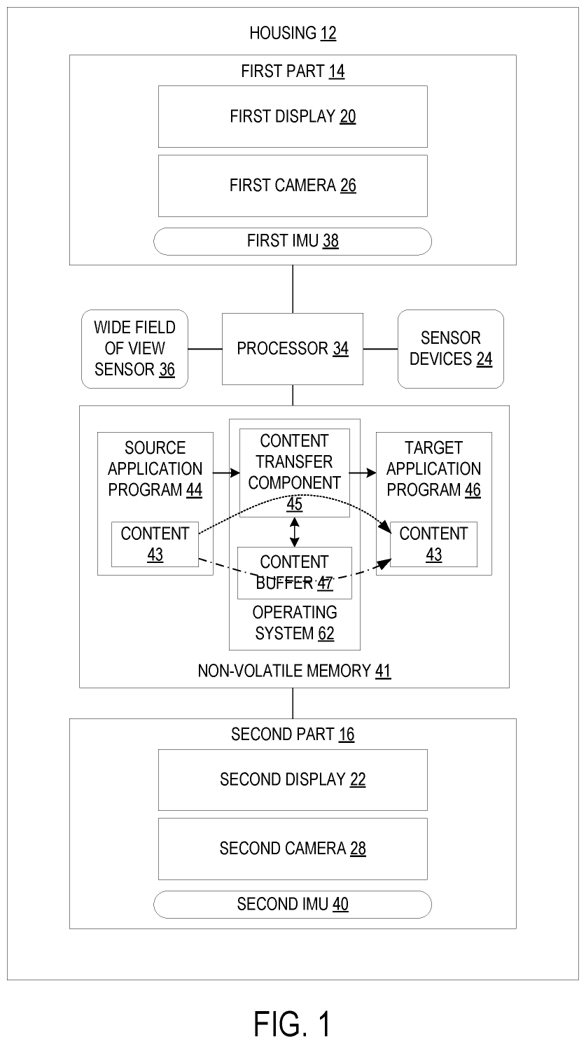

As schematically illustrated in FIG. 1, to address the above identified issues, a mobile computing device 10 is provided. The mobile computing device 10 may, for example, take the form of a smart phone device. In another example, the mobile computing device 10 may take other suitable forms, such as a tablet computing device, a wrist mounted computing device, etc. The mobile computing device 10 may include a housing 12, which, for example, may take the form of a casing surrounding internal electronics and providing structure for displays, sensors, speakers, buttons, etc. The housing 12 may have a first part 14 and a second part 16 coupled by a hinge 18. The first part 14 may include a first touch sensitive display such as a first capacitive touch screen 20, and the second part 16 may include a second touch sensitive display such as a second capacitive touch screen 22. The first and second capacitive touch screens 20, 22 may include respective conductive layers that are configured to recognize touch input from a user via stimulation of an electrostatic field. The hinge 18 may be configured to permit the first and second capacitive touch screens 20, 22 to rotate between angular orientations from a face-to-face angular orientation to a back-to-back angular orientation. Alternatively, other types of touch sensitive displays may be utilized, such as resistive or optical (in-pixel) touch screens.

The mobile computing device 10 may further include one or more sensor devices 24 and a processor 34 mounted in the housing 12, a first camera 26 mounted in the first part 14 of the housing 12, and a second camera 28 mounted in the second part 16 of the housing 12. The one or more sensor devices 24 may be configured to measure the relative angular displacement between the first and second parts 14, 16 of the housing 12, and the processor 34 may be configured to process images captured by the first and second cameras 26, 28 according to a selected function based upon the relative angular displacement measured by the one or more sensor devices 24. In the example implementation of the present application, the one or more sensor devices 24 configured to measure the relative angular displacement between the first and second parts 14, 16 of the housing 12 may be in the form of an angle sensor 24A arranged in the housing 12 of the mobile computing device 10. However, it will be appreciated that another type of sensor, such as one or more inertial measurement units as discussed below, may be configured to measure the relative angular displacement between the first and second parts 14, 16 of the housing 12.

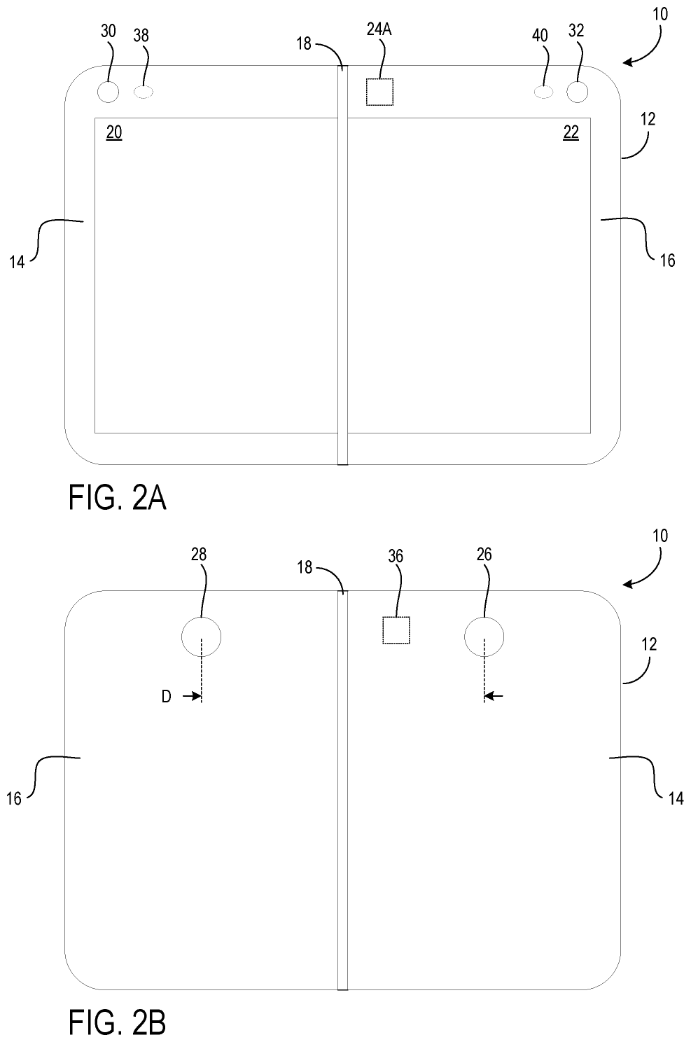

As further illustrated in FIG. 1, a wide field of view sensor 36 may be mounted in the housing 12 of the mobile computing device 10. The wide field of view sensor 36 may be configured to define a plurality of tracking points that determine a spatial orientation of the device 10. In some implementations, such as capturing a panoramic image, a user may scan the environment with the mobile computing device 10 while the cameras 26, 28 capture a plurality of images. In these cases, the tracking points provide data to stabilize the images and assist in the post processing stitching of the images to recreate the environment. As shown in FIGS. 2A and 2B, a distance (D) between the centers of the first and second cameras 26, 28 can be used in conjunction with data from the angle sensor 24A and the wide field of view sensor 36 to further process and stitch together captured images. While the example implementation includes a wide field of view sensor 36, it will be understood that another type of sensor, such as a time-of-flight sensor or a sonar based depth sensor may be used in addition or alternatively to the wide field of view sensor to determine the spatial orientation of the device 10.

Returning to FIG. 1, to provide additional stability and information regarding the orientation of the mobile computing device 10, a first inertial measurement unit 38 may be included in the first part 14 of the housing 12, and a second inertial measurement unit 40 may be included in the second part 16 of the housing 12. When included, the first and second inertial measurement units 38, 40 may each be configured to measure a magnitude and a direction of acceleration in relation to standard gravity to sense an orientation of the respective parts of the housing 12. Accordingly, the inertial measurement units 38, 40 may include accelerometers, gyroscopes, and possibly magnometers configured to measure the position of the mobile computing device 12 in six degrees of freedom, namely x, y, z, pitch, roll and yaw, as well as accelerations and rotational velocities, so as to track the rotational and translational motion of the mobile computing device 10. Additionally or alternatively, the first and second inertial measurement units 38, 40 may be configured to measure the relative angular displacement between the first and second parts 14, 16 of the housing 12. The processor 34 may be further configured to process input from the one or more sensor devices and the first and second inertial measurement units 38, 40 to define a hinge gesture.

FIGS. 2A and 2B illustrate front and back views, respectively, of an example mobile computing device 10 with the first and second parts 14, 16 arranged in a flat orientation. As shown, the example mobile computing device 10 includes a housing 12. As discussed above, the housing 12 may be configured to internally house various electronic components of the example mobile computing device 10, including the processor 34 and various sensor devices. Additionally, the housing 12 may provide structural support for the first and second capacitive touch screens 20, 22 and the sensor devices 24, the wide field of view sensor 36, and the first and second inertial measurement units 38, 40. It will be appreciated that the listed sensor devices are exemplary, and that other types of sensors not specifically mentioned above, such as capacitive touch, ambient light, time-of-flight, and/or sonar based depth sensors, may also be included in the mobile computing device 10.

In some implementations, the mobile computing device 10 may further include a third camera 30 and a fourth camera 32. In such implementations, the processor may be further configured to process images captured by the third and fourth cameras 30, 32. As illustrated in FIG. 2A, the third camera 30 is mounted in the first part 14 of the housing 12, and the fourth camera 32 is mounted in the second part 16 of the housing 12. In the example shown in FIG. 2A, the third and fourth cameras 30, 32 may be configured to face forward with respect to the first and second displays 14, 16. Accordingly, the first and second cameras 26, 28 may be configured to face rearward with respect to the first and second capacitive touch screens 20, 22, as illustrated in FIG. 2B. In the implementations illustrated herein, the directionality of a camera is described in the context of the camera's associated display. Thus, in the example of FIG. 2A, as the first and second capacitive touch screens 20, 22 are facing the same direction, both of the forward facing cameras 30, 32 are also facing the same direction.

In the illustrated examples provided in FIGS. 2A and 2B, the first and third cameras 26, 30 are mounted in the first part 14 of the housing 12, and the second and fourth cameras 28, 32 are mounted in the second part 16 of the housing 12; however, it will be appreciated that the first, second, third, and fourth cameras 26, 28, 30, 32 may be mounted in either the first or second parts 14, 16 of the housing 12 and may be configured as front facing or rear facing cameras. It will be further appreciated that the cameras may be configured as RGB cameras, wide angle cameras, fish eye cameras, or another type of camera.

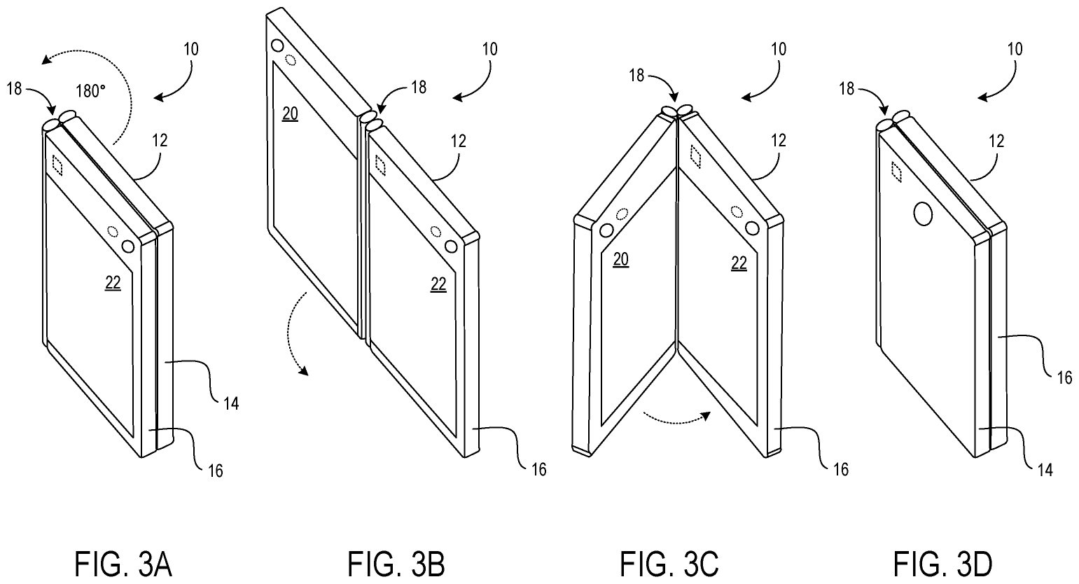

Turning now to FIGS. 3A-3D, the first and second parts 14, 16 of the housing 12 of the mobile computing device 10 are illustrated in a variety of angular orientations. As described above, the hinge 18 permits the first and second parts 14, 16 of the housing 12 to rotate relative to one another such that an angle between the first and second parts 14, 16 can be decreased or increased by the user via applying suitable force to the housing 12 of the mobile computing device 10. The relative angular displacement is measured between an emissive side of each of the first and second capacitive touch screens, 20, 22. As shown in FIGS. 3A-3D, the first and second parts 14, 16 of the housing 12 may be rotated in a range up to 360 degrees from a fully open back-to-back angular orientation, with respect to the first and second capacitive touch screens 20, 22, as shown in FIG. 3A to a fully closed face-to-face orientation as shown in FIG. 3D. While the example implementation illustrates the first and second parts 14, 16 of the housing 12 rotating in a 360 degree orientation, it will be appreciated that alternate implementations of the device may rotate through an angle range that is less than 360 degrees.

In one implementation, the face-to-face angular orientation is defined to have an angular displacement as measured from capacitive touch screen to capacitive touch screen of between 0 degrees and 90 degrees, an open angular orientation is defined to be between 90 degrees and 270 degrees, and the back-to-back orientation is defined to be between 270 degrees and 360 degrees. Alternatively, an implementation in which the open orientation is not used to trigger behavior may be provided, and in this implementation, the face-to-face angular orientation may be defined to be between 0 degrees and 180 degrees, and the back-to-back angular orientation may be defined to be between 180 degrees and 360 degrees. In either of these implementations, when tighter ranges are desired, the face-to-face angular orientation may be defined to be between 0 degrees and 60 degrees, or more narrowly to be between 0 degrees and 30 degrees, and the back-to-back angular orientation may be defined to be between 300 degrees and 360 degrees, or more narrowly to be between 330 degrees and 360 degrees. The 0 degree position may be referred to as fully closed in the fully face-to-face angular orientation and the 360 degree position may be referred to as fully open in the back-to-back angular orientation. In implementations that do not use a double hinge and which are not able to rotate a full 360 degrees, fully open and/or fully closed may be greater than 0 degrees and less than 360 degrees.

As shown in FIG. 3A, in an angular orientation in which the first and second parts 14, 16 are in a fully open back-to-back angular orientation, the first and second capacitive touch screens 20, 22 face away from each other. Thus, while using the mobile computing device 10 in this orientation, the user may only be able to view either the first capacitive touch screen 20 or the second capacitive touch screen 22 at one time. Additionally, with the first and second parts 14, 16 in a fully open back-to-back angular orientation, the forward facing cameras, depicted here as the third and fourth cameras 30, 32, also face in the same direction as their respective capacitive touch screen, and thus also face away from each other.

When the first part 14 of the housing 12 is rotated via the hinge 18 by 180 degrees with respect to the second part 16 of the housing 12, an angular orientation of the mobile computing device 10 in which the first and second parts 14, 16, and thus the first and second capacitive touch screens 20, 22, are arranged in an open side-by-side orientation is achieved, and the first and second capacitive touch screens 20, 22 face the same direction, as illustrated in FIG. 3B. The first part 14 of the housing 12 may be further rotated, as shown in FIG. 3C to a position in which the first and second capacitive touch screens 20, 22 are facing toward each other. Continuing to rotate the first part 14 of the housing 12 may place the capacitive touch screens 20, 22 in a fully closed face-to-face orientation, as shown in FIG. 3D. Such an angular orientation may help protect the capacitive touch screens 20, 22.

Thus, the sequence of angular orientations depicted in FIGS. 3A-3D illustrate that the first and second parts 14, 16 of the housing 12 of the mobile computing device 10 may be rotated a full 360 degrees via the hinge 18 to be arranged at any angular orientation with respect to one another. Accordingly, a user can arrange the mobile computing device 10 in unconventional positions that permit the user to preview and capture images and video content in conditions that require a perspective that would be difficult or impossible to achieve otherwise.

While the example implementation provided herein describes the rotation of the first part 14 of the housing 12 to achieve the various angular orientations, it will be appreciated that either or both of the first and second parts 14, 16 of the housing 12 may be rotated via the hinge 18. It will be further appreciated that the first and second parts 14, 16 of the mobile computing device 10 may rotate from a back-to-back to face-to-face angular orientation as illustrated, as well as from a face-to-face to a back-to-back angular orientation, such as proceeding through the sequence depicted by FIGS. 3A-3D in reverse.

As discussed above, the angle sensor 24A may be configured to measure the relative angular displacement between the first and second parts 14, 16 of the housing 12, and the first and second inertial measurement units 38, 40 may be configured to measure magnitude and a direction of acceleration to sense an orientation of the respective parts of the housing 12. When the user applies force to the housing 12 of the mobile computing device 10 to rotate the first and second parts 14, 16, the inertial measurement units 38, 40 may detect the resulting movement, and the angle sensor 24A may calculate a new current angular orientation resulting after the user ceases rotation of the first and second parts 14, 16 of the housing 12. Input from the angle sensor 24A and the first and second inertial measurement units 38, 40 may be processed by the processor 34 to define a hinge gesture that may determine a camera function. For example, the hinge gesture defined by rotating the first and second capacitive touch screens 20, 22 from a face-to-face angular orientation (see FIG. 3D) to a side-by-side orientation (see FIG. 3B) may determine a panoramic camera function that captures a panoramic image. In addition to the panoramic camera function is described herein, it will be appreciated that a plurality of hinge gestures may be defined to determine corresponding camera functions, as determined by the user or the mobile computing device 10.

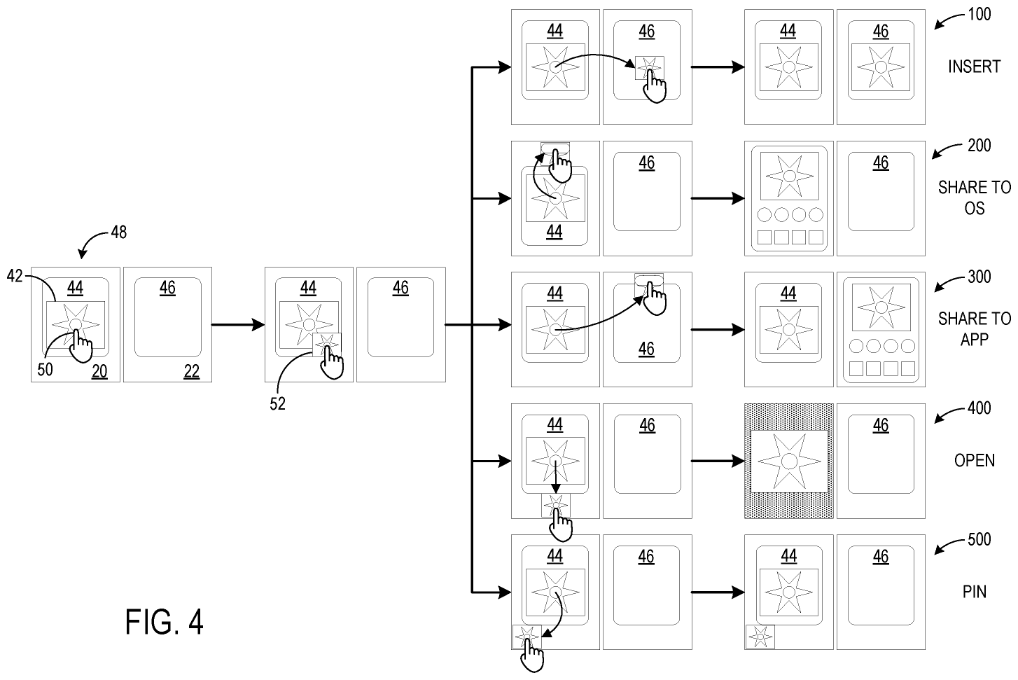

Embodiments and methods for drag and drop operations on the computing device 10 equipped with first and second capacitive touch screens 20, 22 are described in detail below, with reference to FIGS. 4-19. Turning briefly back to FIG. 1, instructions and components for the drag and drop operations described herein may be stored on a non-volatile storage device 41 included in the computing device 10. A source application program 44 may be configured to transfer content 43 via a content transfer component 45 of an operating system 62 of the computing device 10 to a target application program 46. The transfer of the content 43 may occur directly through the content transfer component 45 without any caching or buffering at the operating system level. In other implementations, the content 43 may be stored temporarily in a content buffer 47 by the content transfer component 45. The content 43 may be copied out of the content buffer 47 into the target application program 46 when the user performs a predetermined action using an operating system command such as “paste” or “share.” It will be appreciated that the operating system 62 is multi-threaded and capable of running multiple application programs at the same time.

The content 43 shown in FIG. 1 may be in the form of a virtual object 42 as described herein, and may include digital content such as text, images, videos, files, contact information, calendar events, slides, tables, charts, browser tabs, list items, grid items, notifications, audio files, GIFs, visual stories, and the like, for example. Additionally or alternatively, a virtual object may be comprised of one or more of the above types of digital content, such as a news article that includes both text and images. Depending on characteristics of a source of the virtual object, the virtual object may be dragged from the source and dropped at a target destination, or, alternatively, a copy of the digital content virtual object may be created for the drag and drop operation such that the original version of the digital content of the virtual object remains in the source. It will be appreciated that while the embodiments described herein indicate touch input from a digit of a user, the touch input may alternatively be provided by a specialized stylus or gloves that are equipped to stimulate an electrostatic field of a capacitive touch screen. Additionally or alternatively, the virtual object 42 may be selected and moved with input from a pointer device such as a mouse, for example. Accordingly, the computing device 10 may include a port to support a hardwired connection with the pointer device, and/or the computing device 10 may be configured to communicate with the pointer device over a wireless network.

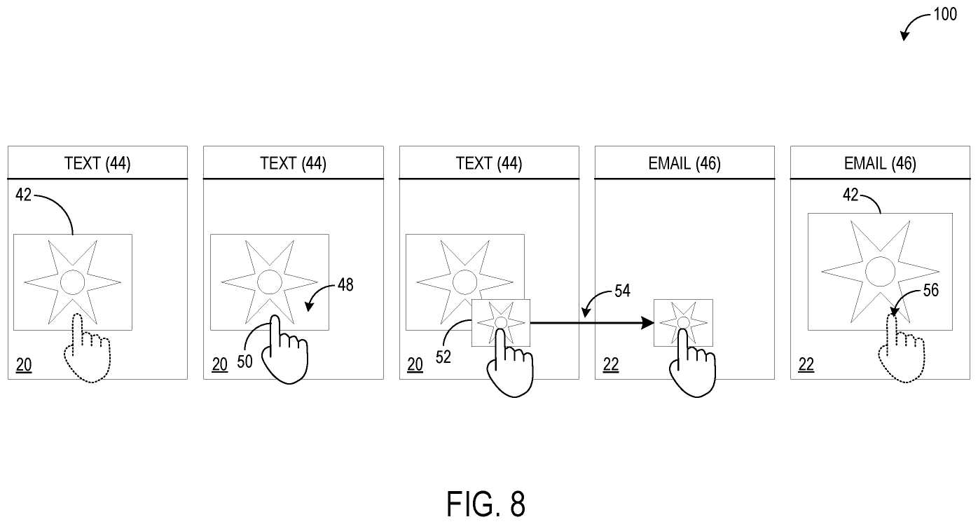

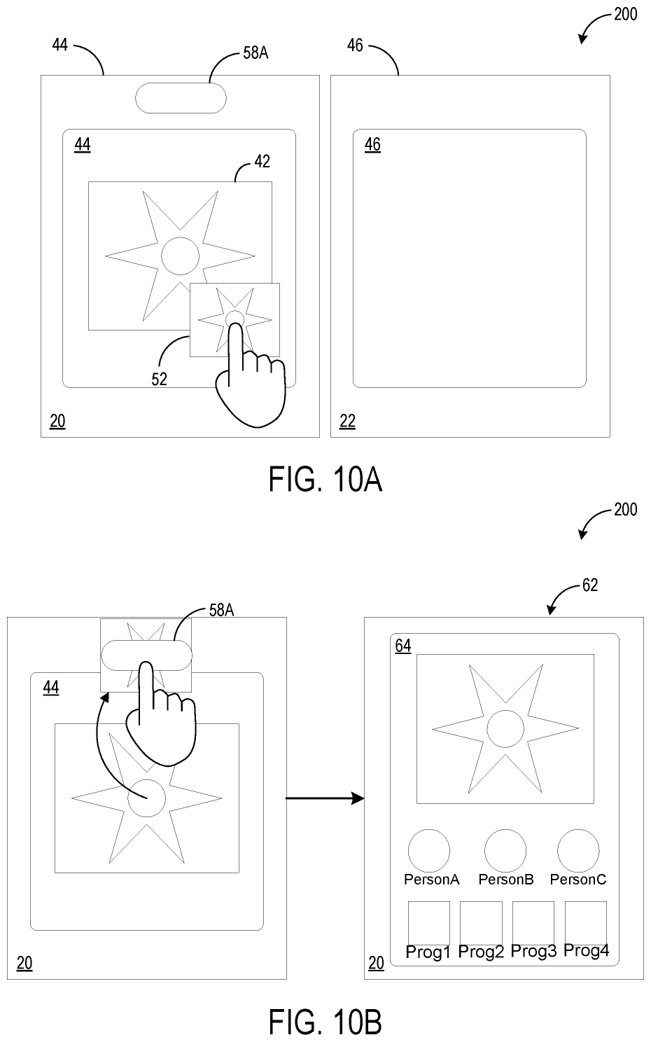

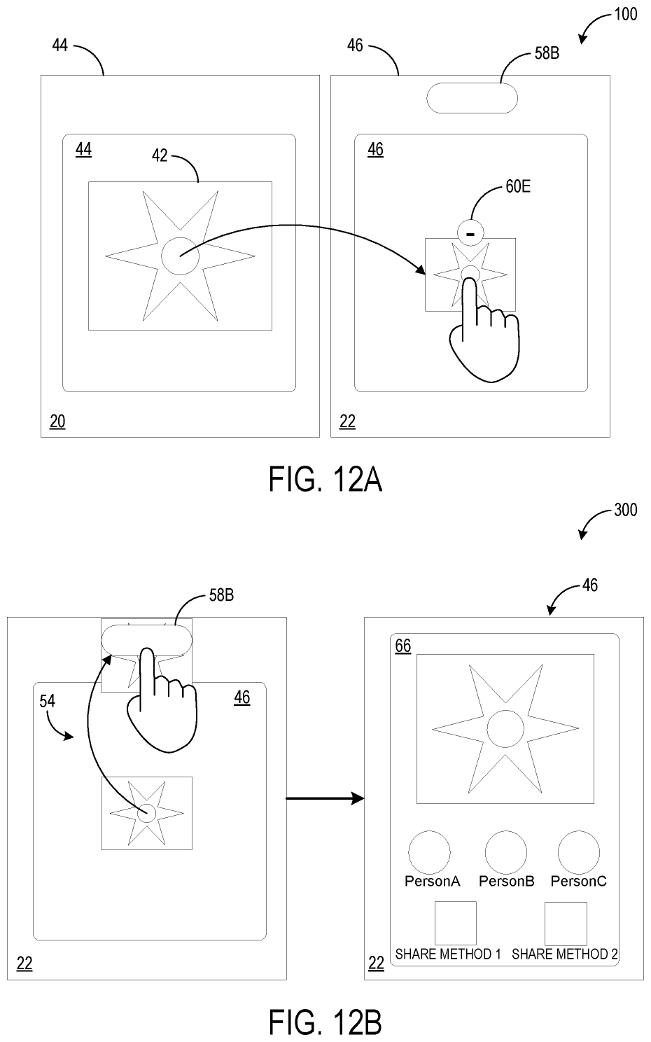

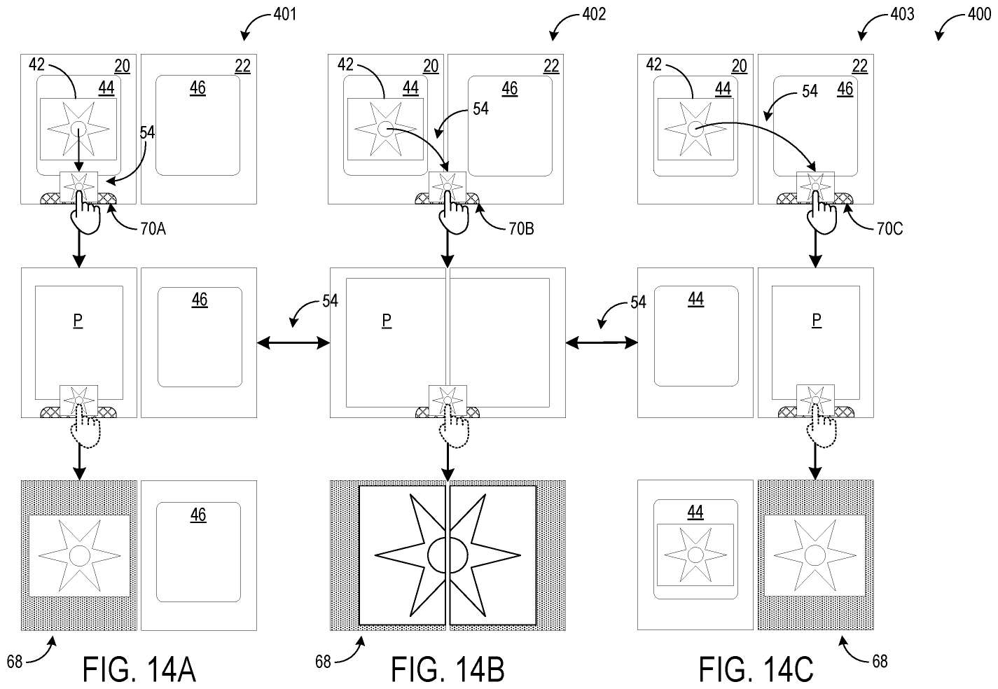

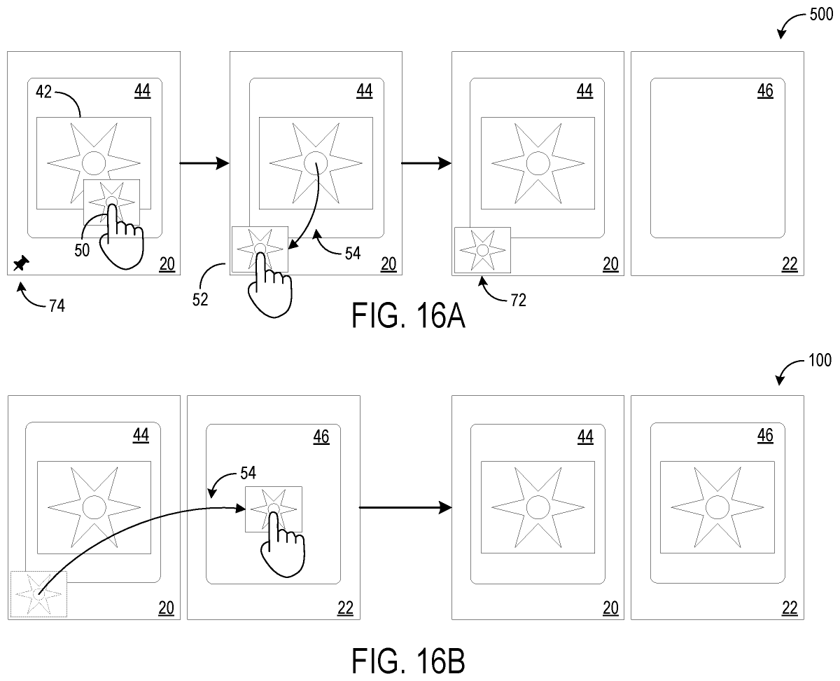

FIG. 4 schematically shows example implementations of drag and drop operations 100, 200, 300, 400, 500 in which a virtual object 42 is dragged from a source and dropped at a target destination. As described in detail below with reference to FIG. 8, the virtual object 42 may be lifted from a source application program 44 and dropped, or inserted, into a target application program 46 in the drag and drop operation 100. As described in detail below with reference to FIG. 10, the virtual object 42 may be lifted from the source application program 44 and shared to an operating system in the drag and drop operation 200. As described in detail below with reference to FIG. 12, the virtual object 42 may be lifted from the source application program 44 and shared to the target application program 46 in the drag and drop operation 300. As described in detail below with reference to FIGS. 14A-14C, the virtual object 42 may be lifted from the source application program 44 and opened in a new instance of an application program in the drag and drop operation 400. As described in detail below with reference to FIGS. 16A and 16B, the virtual object 42 may be lifted from the source application program 44 and pinned to a predetermined location on one of the first and second capacitive touch screens 20, 22 in the drag and drop operation 500.

In each of the implementations of drag and drop operations 100, 200, 300, 400, 500 described herein, the processor 34 may recognize an engagement action 48 on the virtual object 42. The engagement action 48 may be an input gesture from a digit 50 of the user at the location of the virtual object 42 on the first or second capacitive touch screens 20, 22, such as a long press or a hard press, for example. The engagement action 48 may result in lifting the virtual object 42 from the source application program 44.

A visual change in the appearance of the virtual object 42 may indicate a lifted state of the virtual object 42. For example, a change in color, size, elevation shadowing, or opacity may indicate that the virtual object 42 has been lifted. If the user moves the digit 50 that is engaged with the first or second capacitive touch screens 20, 22 at a location of the lifted virtual object 42, the processor may recognize a dragging action 54 of the digit 50. It will be appreciated that the dragging action 54 may have a directionality. The initiation of the dragging action 54 on the lifted virtual object 42 may result in the state of the virtual object 42 switching from the lift state to a picked up state. It will be appreciated that a long press action combined with a lack of the dragging action 54 may trigger a conventional presentation of a context menu for the virtual object 42. The presentation of the context menu may cancel the lifted state of the virtual object 42. Conversely, the initiation of the dragging action 54 on a lifted virtual object 42 to pick up the virtual object 42 may cancel the long press action.

Once picked up, during the dragging operation 54, the virtual object 42 may be depicted as a reduced size image or thumbnail 52 that represents the content of the virtual object 42. If a plurality of virtual objects 42 are selected prior to being lifted, the plurality of virtual objects 42 may be collapsed into a single thumbnail 52 upon recognition of the dragging action 54 that triggers the picked up state. It will be appreciated that the thumbnail 52 is configured to occupy a visual layer above the source application program 44 such that any subsequent action on the thumbnail 52 on the touch screen does not affect the source application program 44.

As the user continues the dragging action 54 while the digit 50 remains in physical contact with at least one of the first or second capacitive touch screens 20, 22, the thumbnail 52 may be moved in the direction of the recognized dragging action 54. As described below, in some cases, such as when a location of the engagement action 48 and the target destination are on separate screens, the dragging action 54 may traverse the hinge 18 of the mobile computing device 10. In such cases, the processor may be configured to recognize a continuation of the dragging action 54 from one capacitive touch screen to the other capacitive touch screen, even during a transient loss of contact between the user's digit 50 and the first and second capacitive touch screens 20, 22. When the thumbnail 52 has been dragged to the target destination, the user may lift the digit 50 to indicate the disengagement action 56. Upon recognition of the disengagement action 56, the processor may be configured to drop the thumbnail 52 at the target destination.

As shown in FIG. 4 and described in detail below, the target destination may be determined at least in part by a detected direction of the dragging action 54, a location on the first or second capacitive touch screens 20, 22 at which the disengagement action 56 is recognized, the presence or absence of an affordance icon 58 or button that indicates the availability of a specific target destination, whether a drag and drop operation is supported by the virtual object 42 and/or the target destination, and the compatibility of the virtual object 42 with the target destination.

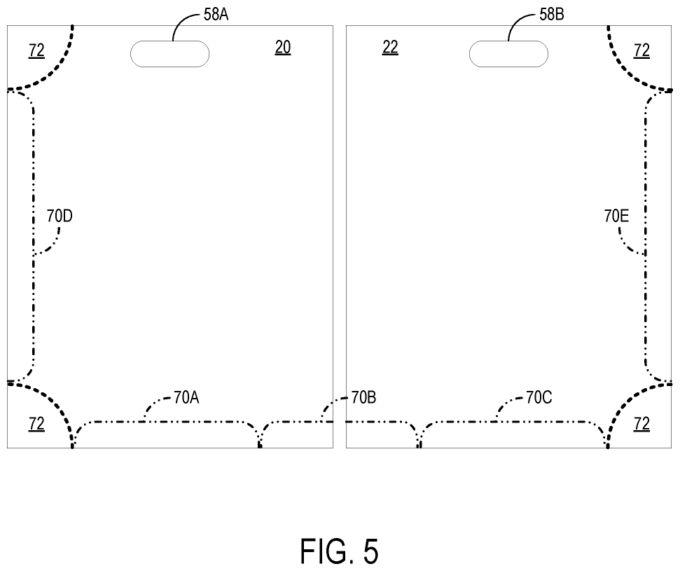

Turning briefly to FIG. 5, various target destinations of the drag and drop operations 200, 300, 400, and 500 are schematically illustrated. As described below with reference to FIGS. 10A and 10B, dropping the virtual object 42 at an affordance icon 58A on the same capacitive touch screen as the source application program 44 may share the virtual object 42 to an operating system. As described below with reference to FIGS. 12A and 12B, dropping the virtual object 42 at an affordance icon 58B on the other capacitive touch screen as the source application program 44 may share the virtual object 42 to the target application program 46. As described below with reference to FIGS. 14A-14C, dropping the virtual object 42 at one of drop locations 70A-70E may open a new instance of the target application program 46. As described in detail below, the position of the drop location 70 may determine where the new instance of the target application program 46 opens. As described below with reference to FIGS. 16A and 16C, dropping the virtual object 42 at a pin location 72 at an outer corner of the mobile computing device 10 may temporarily pin the virtual object 42 to the pin location 72.

It will be appreciated that the source application program 44 and the target destination may be on the same one of the first or second capacitive touch screens 20, 22. Alternatively, the source application program 44 may be on one of the first or second capacitive touch screens 20, 22, and the target destination may be on the other of the first or second capacitive touch screens 20, 22. When the source application program 44 and the target destination are on separate screens, the dragging action 54 may traverse the hinge 18 of the mobile computing device 10.

The digit 50 of the user is recognized as being in an engaged state with the virtual object 42 during the drag and drop operations 100, 200, 300, 400, 500 when the digit 50 is in contact with the first or second capacitive touch screens 20, 22 at a location of the virtual object 42. It will be appreciated that the digit 50 may continue to be recognized as being in the engaged state with the virtual object 42 in the event that contact between the digit 50 and the first or second capacitive touch screens 20, 22 is temporarily disrupted, provided that the digit 50 remain within a predetermined distance of the first or second capacitive touch screens 20, 22 at a location of the virtual object 42 such that a hover state is activated.

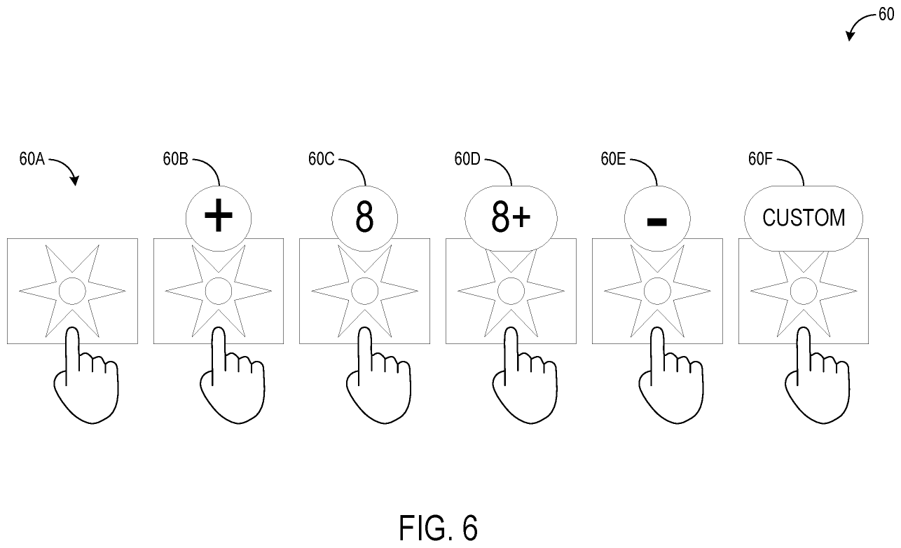

In some embodiments described herein, the recognition of certain actions during the drag and drop operation may trigger a display of information with regard to the status of the virtual object 42. Such information may be conveyed to the user in the form of an informational icon 60 that is displayed adjacent the thumbnail 52. FIG. 6 illustrates examples of informational icons 60 that may be displayed to indicate potential outcomes of drag and drop operations described herein. Each of the informational icons 60 may be represented as a charm, for example, which is configured to be located near a point of contact between the digit 50 of the user and the first or second capacitive touch screens 20, 22, such as slightly above the digit 50, as illustrated in FIG. 6. The lack of an informational icon 60, as shown by 60A in FIG. 6, may indicate that the virtual object 42 is not configured for the drag and drop operation 100. The informational icon 60B may display a plus sign, indicating that the target destination supports drag and drop functionality, and the virtual object 42 will be inserted at the target destination upon recognition of the disengagement action 60. In some use case scenarios, it may be possible to select more than one virtual object 42 for a drag and drop operation. In such cases, the informational icon 60C may display a number to indicate how many virtual objects 42 are selected. When multiple virtual objects 42 are selected and the target destination supports drag and drop functionality, the informational icon 60D may display a number and a plus sign to indicate how many virtual objects 42 will be inserted at the target destination upon recognition of the disengagement action 60. In cases when the target destination is not configured for drag and drop functionality and/or the virtual object 42 is not compatible with the target destination, the informational icon 60E may display a minus sign to indicate that virtual object 42 will not be inserted at the target destination. As described in detail below, when the virtual object 42 is not able to be inserted into the target destination or if the dragging action 54 is recognized to be in a specific direction that indicates an outcome different than inserting the virtual object 42 into the target destination, the informational icon 60F may be displayed. The informational icon 60F may include text to indicate a custom action or when a sharing functionality is available for the virtual object 42.

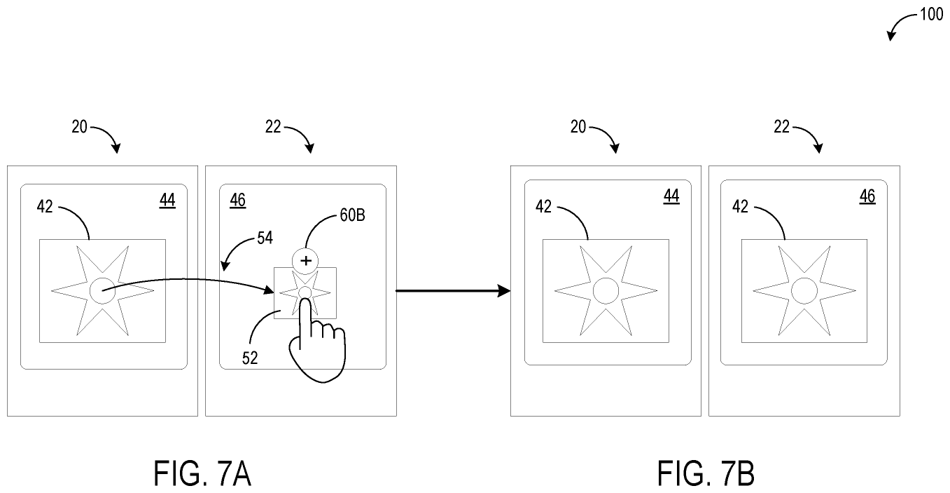

An example of the drag and drop operation 100 is shown in FIGS. 7A and 7B. The display of the informational icon 60B in FIG. 7A indicates that the virtual object 42 will be inserted into the target application program 46 when the disengagement action 56 is recognized. Additionally, the presence of the affordance icon 58 at the top of the target application program 46 indicates that the virtual object 42 could alternatively be shared to the target application program 46. The affordance icon 58 is not highlighted, indicating that while it is an available option, it is not the currently selected option. FIG. 7B illustrates the outcome of the drag and drop operation 100 in which the virtual object 42 into an empty canvas of the target application program 46.

FIG. 8 schematically shows an example of the drag and drop operation 100 in which a virtual object 42 is dragged from a source application program 44, such as a text messaging application program, for example, and inserted into a target application program 46, such as an email application program, for example. As described above, the processor 34 may recognize the engagement action 48 on the virtual object 42 and lift the virtual object 42 from the source application program 44.

In response to the recognized engagement action 48, the processor 34 may be configured to pick up the virtual object 42. As described above, the virtual object 42 may be shown as the thumbnail 52 that represents the content of the virtual object 42, as illustrated in FIG. 8.

As described above, when the user moves the digit 50 that is engaged with the first or second capacitive touch screens 20, 22 at a location of the thumbnail 52, the processor may recognize a dragging action 54 and move the thumbnail 52 in the direction of the recognized dragging action 54. The user may indicate the disengagement action 56 by stopping movement of the digit 50 and lifting the digit 50 up to break contact with the first or second capacitive touch screens 20, 22. Upon recognition of the disengagement action 56, the thumbnail 52 is dropped.

In the example illustrated in FIG. 8, the dropping of the thumbnail 52 at the target destination results in an insertion of the virtual object 42 into the target application program 46. Depending upon the type of digital content included in the virtual object 42 and the constraints of the target application program 46, the virtual object 42 may be inserted at a user-determined location in a visible window of the target application program 46. Alternatively, the target application program 46 may determine the location at which the virtual object 42 is inserted. For example, when only a single drop target location is identified, inserting a file into a message compose view or inserting text into an empty canvas may result in an imprecise, general insertion location into the target application program 46. In some use case scenarios, multiple drop target locations may be present on the same screen. When this occurs, the location of the insertion may be directed to one of the identified target locations, such as inserting text into a search box in a feed or inserting an image into a contact window in a feed. When direct manipulation of the insertion of the virtual object 42 into the target location is available, the user may indicate a precise positioning of the virtual object 42 into the target location, such as inserting text between sentences or inserting an image into an open canvas. It will be appreciated that the examples of drop target location precision are merely provided as non-limiting examples, and that numerous additional possibilities are available. It will be further appreciated that when the virtual object 42 is inserted into the target application program 46, the corresponding digital content included in the source application program 44 is preserved and does not change.

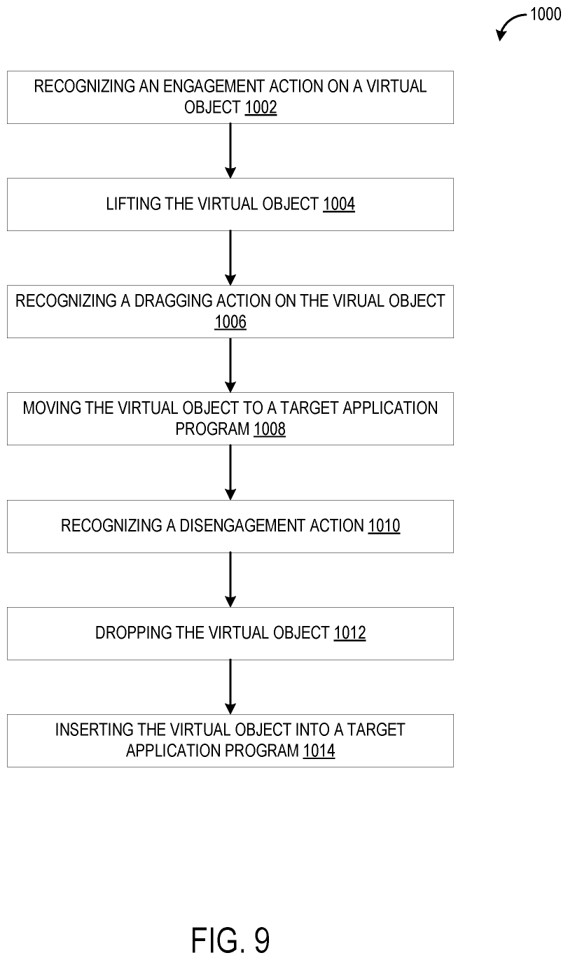

FIG. 9 shows an example method 1000 for the drag and drop operation 100 in which a virtual object is inserted into an application program, according to one implementation of the present disclosure. Method 1000 is preferably implemented on a hinged mobile computing device having a first touch screen and a second touch screen, such as the mobile computing device described above. However, it will be appreciated that the method 1000 may be implemented on any other computing device that is equipped with at least one capacitive touch screen and suitable computer hardware. The method 1000 may be executed by a processor included in the mobile computing device, for example.

At step 1002, the method 1000 may include recognizing an engagement action of a digit on a virtual object displayed by a source application program on one of the first or second capacitive touch screens. As discussed above the engagement action may be an input gesture from the digit of the user on the first or second capacitive touch screens, such as a long press or a hard press, for example.

Continuing from step 1002 to step 1004, the method 1000 may include, in response to the recognized engagement action, lifting the virtual object.

Proceeding from step 1004 to step 1006, the method 1000 may include recognizing a dragging action of the digit with the virtual object as the user moves the digit that is engaged with the first or second capacitive touch screens at a location of the virtual object.

Advancing from step 1006 to step 1008, the method 1000 may include moving the virtual object according to the dragging action to a target destination on the other of the first or second touch screens.

Continuing from step 1008 to step 1010, the method 1000 may include recognizing a disengagement action of the digit from the virtual object. As described above, the user may lift the digit to indicate a disengagement action.

Proceeding from step 1010 to step 1012, the method 1000 may include dropping the virtual object at the target destination. In method 1000, the target destination is within an open window of a target application program, and dropping the virtual object in the open window of the target application program inserts the virtual object at a determined location within the open window of the target application program, as indicated at step 1014 of the method 1000. As described above, the insertion location of the virtual object may be determined by the user or by the constraints of the target application program, for example. In some implementations, the method 1000 may further include, prior to dropping the virtual object at the target destination, displaying a preview of the virtual object as it would appear after insertion into the target application.

Sharing the virtual object 42 presents the virtual object 42 in a share graphical user interface (GUI) (e.g., share sheet) rather than inserting it into a specific location in the target application program 46, such as in the drag and drop operation 100 described above. FIGS. 10A and 10B schematically show an example of the drag and drop operation 200 in which a virtual object 42 is dragged from a source application program 44 and shared to an operating system 62. As described above, the processor 34 may recognize the engagement action 48 and lift the thumbnail 52 representing the virtual object 42. The processor 34 may further recognize the dragging action 54 and move the thumbnail 52 in accordance with a detected movement of the user's digit 50 that is engaged with the first or second capacitive touch screens 20, 22 at a location of the thumbnail 52.

As shown in the example drag and drop operation 200 illustrated in FIG. 10A, the source application program 44 may be displayed on the first capacitive touch screen 20, and the affordance icon 58A of the source application program 44 may be visible at a top of the source application program 44, indicating that the affordance icon 58A of the source application program 44 is a viable target destination. Instead of performing the dragging action 54 to move the thumbnail 52 to the target application program shown on the second capacitive touch screen 22, the user may opt to drag the thumbnail 52 in an upward direction to the affordance icon 58A of the source application program 44. Additionally or alternatively, the drag and drop operation 100 to insert the virtual object 42 into the target application 46 may be indicated as unavailable. When the thumbnail 52 is recognized as being at the location of the affordance icon 58A of the source application program 44, the affordance icon 58A of the source application program 44 becomes highlighted, thereby indicating that a subsequent disengagement action 56 would result in the sharing of the virtual object 42 to the operating system 62, as shown in FIG. 10B. When the user completes the drag and drop operation 200 to share the virtual object 42 to the operating system 62, the virtual object 42 is presented in an operating system share GUI 64 of the operating system 62, as illustrated in FIG. 10B.

As described above, the type of digital content included in the virtual object 42 and the constraints of the operating system 62 may determine how the virtual object 42 may be displayed in the operating system share GUI 64 of the operating system 62. In the illustrated operating system share GUI 64, programs 1-4 are presented as share application options, and persons A-C are presented as share recipients, based on their availability to share the selected virtual object 42. For example, if the virtual object 42 is an image file, the programs may be an SMS messaging application, an internet-based messaging application, an email application, and a social network application, each of which is capable of sharing that type of content. The selection of the contacts (persons) may be made based on the availability of said contacts to receive content through each program. Thus, the people may be dynamically filtered as the program is selected. The user may select both a program and a contact (person) to complete the share via the operating system share GUI.

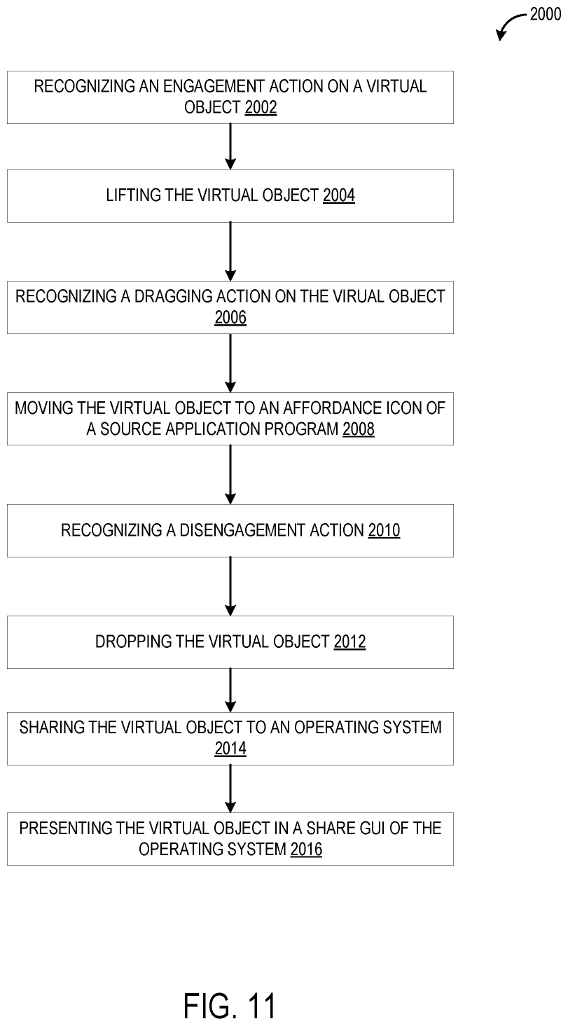

FIG. 11 shows an example method 2000 for the drag and drop operation 200 in which a virtual object is shared to an operating system, according to one implementation of the present disclosure. Method 2000 is preferably implemented on a hinged mobile computing device having a first touch screen and a second touch screen, such as the mobile computing device described above. However, it will be appreciated that the method 2000 may be implemented on any other computing device that is equipped with at least one capacitive touch screen and suitable computer hardware. The method 2000 may be executed by a processor included in the mobile computing device, for example.

At step 2002, the method 2000 may include recognizing an engagement action of a digit on a virtual object displayed by a source application program on one of the first or second capacitive touch screens. As discussed above the engagement action may be an input gesture from a digit of the user on the first or second capacitive touch screens, such as a long press or a hard press, for example.

Continuing from step 2002 to step 2004, the method 2000 may include, in response to the recognized engagement action, lifting the virtual object.

Proceeding from step 2004 to step 2006, the method 2000 may include recognizing a dragging action of the digit with the virtual object as the user moves the digit that is engaged with the first or second capacitive touch screens at a location of the virtual object.

Advancing from step 2006 to step 2008, the method 2000 may include moving the virtual object according to the dragging action. As described above, the virtual object is moved to the affordance icon of the source application program during the drag and drop operation 200.

Continuing from step 2008 to step 2010, the method 2000 may include recognizing a disengagement action of the digit from the virtual object. As described above, the user may lift the digit to indicate a disengagement action when the virtual object is at the location of the affordance icon of the source application program.

Proceeding from step 2010 to step 2012, the method 2000 may include dropping the virtual object at the affordance icon of the source application program. According to the drag and drop operation 200, dropping the virtual object at the affordance icon of the source application program results in the sharing of the virtual object to an operating system, as indicated at step 2014 of the method 2000.

Advancing from step 2014 to step 2016, the method 2000 may include presenting the virtual object in an operating system share GUI. As described above, the type of digital content included in the virtual object and the constraints of the operating system may determine how the virtual object may be displayed in the GUI of the operating system. Specifically, the programs and contacts that are selected to populate the operating system share GUI may be selected based on these factors.

FIGS. 12A and 12B schematically show an example of the drag and drop operation 300 in which a virtual object 42 is dragged from a source application program 44 and shared to the target application program 46. As described above, the processor 34 may recognize the engagement action 48 and lift the thumbnail 52 representing the virtual object 42. The processor 34 may further recognize the dragging action 54 and move the thumbnail 52 in accordance with a detected movement of the user's digit 50 that is engaged with the first or second capacitive touch screens 20, 22 at a location of the thumbnail 52.

As shown in the example drag and drop operation 100 illustrated in FIG. 12A, the source application program 44 may be displayed on the first capacitive touch screen 20, and the target application program 46 may be displayed on the second capacitive touch screen 22. The affordance icon 58B of the target application program 46 may be visible at a top of the target application program 46, indicating that the affordance icon 58B of the target application program 46 is a viable target destination.

Upon attempting to perform the drag and drop operation 100 to insert the virtual object 42 into the target application program 46, the informational icon 60E may appear to indicate that the drag and drop operation 100 is unavailable. As described above, this situation may arise when the target destination is not configured for drag and drop functionality and/or the virtual object 42 is not compatible with the target destination.

When the drag and drop operation 100 is unavailable, the user may opt to perform drag and drop operation 300 and move the thumbnail 52 in an upward direction to the affordance icon 58B of the target application program 46. When the thumbnail 52 is recognized as being at the location of the affordance icon 58B of the target application program 46, the affordance icon 58B of the target application program 46 becomes highlighted, thereby indicating that a subsequent disengagement action 56 would result in the sharing of the virtual object 42 to the target application program 46, as shown in FIG. 12B. When the user completes the drag and drop operation 300 to share the virtual object 42 to the target application program 46, the virtual object 42 presented in an application-specific share graphical user interface (GUI) 66 of the target application program 46, as illustrated in FIG. 12B. Unlike the operating system share GUI 64 of the operating system 62 described above with reference to the drag and drop operation 200, the application-specific share GUI 66 of the target application program 46 may be customized or filtered to display the virtual object 42 according to available actions (e.g., share method 1 and share method 2 as depicted) associated with the target application program 46 and/or the target application program 46 in the context of the operating system 62 installed on the mobile computing device 10. As one specific example, a target program that is a communications program may be configured to share a content item as an SMS message or as an email as the actions or share methods.

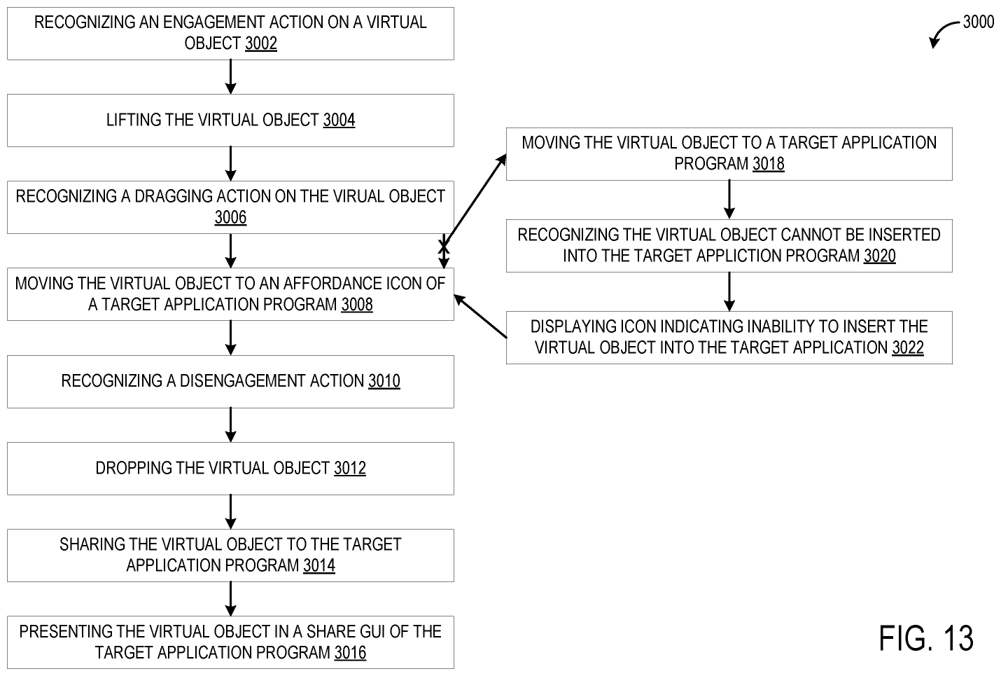

FIG. 13 shows an example method 3000 for the drag and drop operation 300 in which the target destination is an affordance icon of a target application program, according to one implementation of the present disclosure. Method 3000 is preferably implemented on a hinged mobile computing device having a first touch screen and a second touch screen, such as the mobile computing device described above. However, it will be appreciated that the method 3000 may be implemented on any other computing device that is equipped with at least one capacitive touch screen and suitable computer hardware. The method 3000 may be executed by a processor included in the mobile computing device, for example.

At step 3002, the method 3000 may include recognizing an engagement action of a digit on a virtual object displayed by a source application program on one of the first or second capacitive touch screens. As discussed above the engagement action may be an input gesture from a digit of the user on the first or second capacitive touch screens, such as a long press or a hard press, for example.

Continuing from step 3002 to step 3004, the method 3000 may include, in response to the recognized engagement action, lifting the virtual object.

Proceeding from step 3004 to step 3006, the method 3000 may include recognizing a dragging action of the digit with the virtual object as the user moves the digit that is engaged with the first or second capacitive touch screens at a location of the virtual object.

Advancing from step 3006 to step 3008, the method 3000 may include moving the virtual object according to the dragging action. As described above, the virtual object is moved to the affordance icon of the target application program during the drag and drop operation 300.

Continuing from step 3008 to step 3010, the method 3000 may include recognizing a disengagement action of the digit from the virtual object. As described above, the user may lift the digit to indicate a disengagement action when the virtual object is at the location of the affordance icon of the target application program.

Proceeding from step 3010 to step 3012, the method 3000 may dropping the virtual object at the affordance icon of the target application program. According to the drag and drop operation 300, dropping the virtual object at the affordance icon of the target application program shares the virtual object to the target application program, as indicated at step 3014 of the method 3000.

Advancing from step 3014 to step 3016, the method 2000 may include presenting the virtual object in an application-specific share GUI of the target application program. As described above, the application-specific share GUI may be customized or filtered to display the virtual object according to available actions associated with the target application program and/or the operating system. For example, the application specific share GUI may present the user with one or more application-specific share methods for the type of content of the virtual object, as well as application specific contacts to which the share methods apply, as discussed above.

Additionally or alternatively, in some use case scenarios, a user may attempt to drag the virtual object to a target application program for insertion into the target application program. As described above, the insertion of the virtual object into the target application program may fail when the target destination is not configured for drag and drop functionality and/or the virtual object is not compatible with the target destination.

In such situations, the method 3000 may alternatively return to step 3006. Continuing from step 3006 to step 3018, the method 3000 may include moving the virtual object to a target application program for insertion into the target application program.

Proceeding from step 3018 to step 3020, the method 3000 may alternatively include recognizing that the virtual object cannot be inserted into the target application program.

Advancing from step 3020 to step 3022, the method 3000 may alternatively include displaying an informational icon that indicates to the user that the virtual object cannot be inserted into the target application program.

At step 3022, the user may decide to share the virtual object to the target application program according to the drag and drop operation 300. Accordingly, the method 3000 may include returning to step 3008 and continuing through step 3016 to share the virtual object to the target application program and present the virtual object in a graphical user interface of the target application program.

FIGS. 14A-14C schematically show examples of the drag and drop operation 400 in which a virtual object 42 is dragged from a source application program 44 and opened in a new instance of an application program. The new instance of an application program may be a new instance of the source application program 44, a new instance of the target application program 46, or a new instance of a default application program 68. It will be appreciated that the default application program 68 is commonly understood to be an application program in which a specific file type opens by default and may be defined by the user. For simplicity, the examples provided herein show the virtual object opening in a new instance of the default application program 68.

As shown in the example drag and drop operation 400 illustrated in FIGS. 14A-14C, the source application program 44 may be displayed on the first capacitive touch screen 20, and the target application program 46 may be displayed on the second capacitive touch screen 22. Either or both of the first and second capacitive touch screens 20, 22 may be configured to have one or more drop regions 70. The drop regions 70 may be located at one or more specific regions of the first and/or second capacitive touch screens 20, 22 in a default configuration of an application program or the operating system 62. Additionally or alternatively, the drop regions 70 may be defined by the user.

As described above, the processor 34 may recognize the engagement action 48 and lift the thumbnail 52 representing the virtual object 42. The processor 34 may further recognize the dragging action 54 and move the thumbnail 52 in accordance with a detected movement of the user's digit 50 that is engaged with the first or second capacitive touch screens 20, 22 at a location of the thumbnail 52.

When the thumbnail 52 is recognized as being at one of the one or more drop regions 70, the processor 34 may be configured to open the virtual object 42 associated with the thumbnail 52 in the new instance of the default application program 68. For example, as shown by a first implementation 401 of the drag and drop operation 400 in FIG. 14A, dragging and dropping the thumbnail 52 at the drop region 70A at the bottom of the first capacitive touch screen 20 on which the source application program 44 is displayed results in the virtual object 42 being opened in the new instance of the default application program 68 that is displayed on the first capacitive touch screen 20.

Dragging and dropping the thumbnail 52 at the drop region 70B that includes the hinge 18 and spans bottoms of both of the first and second capacitive touch screens 20, 22 results in the virtual object 42 being opened in the new instance of the default application program 68 that is displayed across both of the first and second capacitive touch screens 20, 22, as illustrated in a second implementation 402 of the drag and drop operation 400 in FIG. 14B.

FIG. 14C shows a third implementation 403 of the drag and drop operation 400 in which dragging the thumbnail 52 from the first capacitive touch screen 20 and dropping it at the drop region 70C at the bottom of the second capacitive touch screen 22 results in the virtual object 42 being opened in the new instance of the default application program 68 that is displayed on the second capacitive touch screen 22.

With reference to FIG. 5, drop regions 70D, 70E may also be available on an outer side of the first and second capacitive touch screens 20, 22, respectively. Dropping a thumbnail 52 at either of the drop regions 70D, 70E may result in the virtual object 42 being opened in a new instance of an application program on the same capacitive touch screen as the drop location 70D, 70E at which it was dropped, and moving another application program to the other capacitive touch screen. For example, dropping the thumbnail 52 at the drop location 70D on the outer side of the first capacitive touch screen 20 that while it was displaying an application program may open the virtual object 42 in a new instance of an application program on the first capacitive touch screen 20 and cause the displayed application program to move to the second capacitive touch screen 22.

It will be appreciated that the drop regions 70 described herein are non-limiting examples of how and where the drop regions 70 may be configured and located, and that the drop regions 70 may be configured or located in other configurations additionally or alternatively to those described herein. Additionally, as shown in FIGS. 14A-14C, a preview P of how the virtual object 42 may appear when opened in the default application program 68 may be displayed, and a user may perform an additional dragging action 54 to move the thumbnail 52 from one drop region 70 to another drop region 70 prior to dropping it to change how the virtual object 42 is opened in the default application program 68.

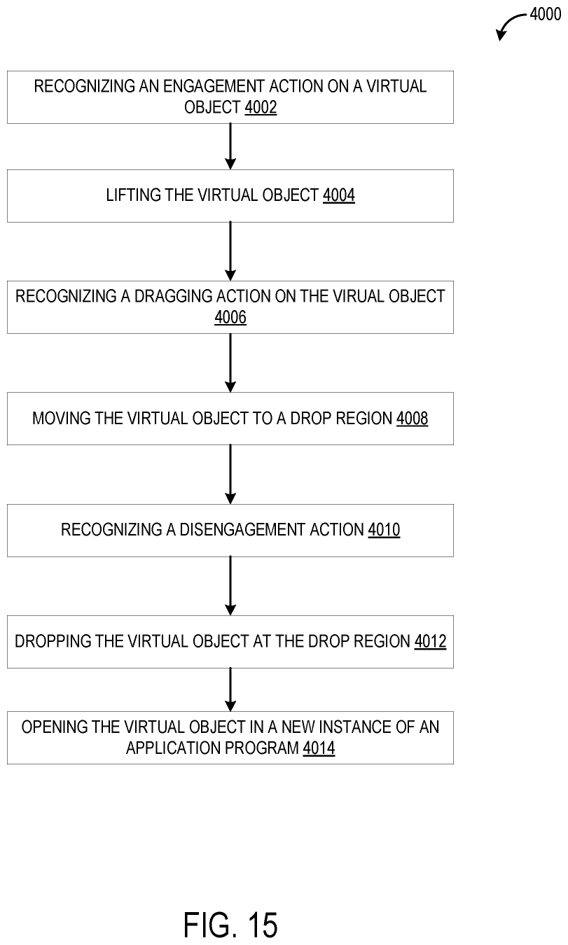

FIG. 15 shows an example method 4000 for the drag and drop operation 400 in which the target destination is a drop region located along an edge of the first or second touch screen, according to one implementation of the present disclosure. Method 4000 is preferably implemented on a hinged mobile computing device having a first touch screen and a second touch screen, such as the mobile computing device described above. However, it will be appreciated that the method 4000 may be implemented on any other computing device that is equipped with at least one capacitive touch screen and suitable computer hardware. The method 4000 may be executed by a processor included in the mobile computing device, for example.

At step 4002, the method 4000 may include recognizing an engagement action of a digit on a virtual object displayed by a source application program on one of the first or second capacitive touch screens. As discussed above the engagement action may be an input gesture from a digit of the user on the first or second capacitive touch screens, such as a long press or a hard press, for example.

Continuing from step 4002 to step 4004, the method 4000 may include, in response to the recognized engagement action, lifting the virtual object.

Proceeding from step 4004 to step 4006, the method 4000 may include recognizing a dragging action of the digit with the virtual object as the user moves the digit that is engaged with the first or second capacitive touch screens at a location of the virtual object.

Advancing from step 4006 to step 4008, the method 4000 may include moving the virtual object according to the dragging action . As described above, in the first implementation of the method 4000, the virtual object is moved to the drop region.

Continuing from step 4008 to step 4010, the method 4000 may include recognizing a disengagement action of the digit from the virtual object. As described above, the user may lift the digit to indicate a disengagement action when the virtual object is at the location of the drop region.

Proceeding from step 4010 to step 4012, the method 4000 may include dropping the virtual object at the drop region to open the virtual object in a new instance of a default application program. The new instance of the application program may be displayed on a same touch screen of the first and second touch screens as the drop region at which the virtual object was dropped. For example, as described above, dropping the virtual object at the drop region at the bottom of the first capacitive touch screen results in the opening of the virtual object in a new instance of the default application program that is displayed on the first capacitive touch screen, and dropping the virtual object at the drop region at the bottom of the second capacitive touch screen results in the opening of the virtual object in a new instance of the default application program that is displayed on the second capacitive touch screens. When the virtual object is dropped at the drop region that spans bottoms of both of the first and second capacitive touch screens, the virtual object may be opened in a new instance of the default application program that is displayed across both of the first and second capacitive touch screens,

FIGS. 16A and 16B schematically show an example of the drag and drop operation 500 in which a virtual object 42 is pinned to a predetermined location on one of the first and second capacitive touch screens 20, 22 prior to being shared or opened. When the mobile computing device 10 is in a single screen mode in which the first and second capacitive touch screens 20, 22 are in a back-to-back orientation, the drag and drop operation 500 may be performed on one of the first or second capacitive touch screens 20, 22. In this example, a user may lift and drag the thumbnail 52 of the virtual object 42 from the source application program 44 to a pin location 72, such as a corner of one of the first or second capacitive touch screens 20, 22, and open the target application program 46 on the same capacitive touch screen as the pinned virtual object 42.

Additionally or alternatively, the user may open the mobile computing device 10 to enable a double screen mode in which the first and second capacitive touch screens 20, 22 are in a side-by-side orientation to enable the pinned virtual object 42 to be moved from a pin location on one of the first or second capacitive touch screens 20, 22 to a pin location on the other of the first or second capacitive touch screens 20, 22. The side-by-side orientation of the mobile computing device 10 may also enable the user to perform a subsequent drag and drop operation on the pinned virtual object 42 to move the virtual object 42 from the pin location 72 on one of the first or second capacitive touch screens 20, 22 to the target destination on the other of the first or second capacitive touch screens 20, 22.

For the sake of brevity, an example of the drag and drop operation 500 in which the mobile computing device 10 is in the single screen mode is described herein. As described above, the processor 34 may recognize the engagement action 48 and lift the thumbnail 52 representing the virtual object 42. The processor 34 may further recognize the dragging action 54 and move the thumbnail 52 in accordance with a detected movement of the user's digit 50 that is engaged with the first or second capacitive touch screens 20, 22 at a location of the thumbnail 52.

As shown in the example drag and drop operation 500 illustrated in FIG. 16A, the source application program 44 may be displayed on the first capacitive touch screen 20 of the mobile computing device 10, and a pin icon 74 indicating the pin location 72 may be visible at a corner of the first capacitive touch screen 20. In the illustrated example, the pin icon 74 appears at the lower left corner of the first capacitive touch screen 20. When the thumbnail 52 is dragged to the pin icon 74 and the disengagement action 56 is recognized, the processor 34 may be configured to pin the thumbnail 52 to the pin location 72. The pinned virtual object 42 may continue to be displayed as the reduced-size thumbnail 52 after the disengagement action 56 so that it does not impede the view of other content displayed on the first capacitive touch screen 20. Further, while the pinned thumbnail 52 may appear visible above content displayed on the first or second capacitive touch screen 20, 20, the pinned thumbnail 52 may be reduced in opacity such that a user's ability to view content below the pinned thumbnail 52 is not obstructed.

The pin location 72 may be a temporary location for the virtual object 42. A subsequent drag and drop operation may be performed on the pinned virtual object 42 to move the virtual object 42 to a target destination. For example, after pinning the virtual object 42 to the pin location 72, the user may then open the target application program 46 on the second capacitive touch screen 22 and perform the drag and drop operation 100 to insert the virtual object 42 into the target application program 46, as shown in FIG. 16B. In the case of a failed drop, the thumbnail 52 may return to the nearest pin location 72.

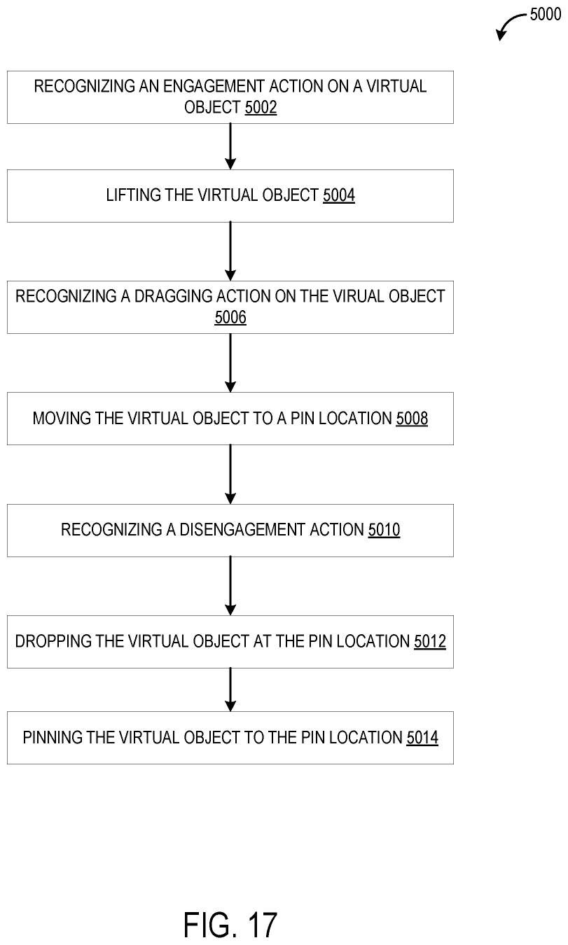

FIG. 17 shows an example method 5000 for the drag and drop operation 500 in which a virtual object is pinned to a predetermined location on a capacitive touch screen, according to one implementation of the present disclosure. Method 5000 is preferably implemented on a hinged mobile computing device having a first touch screen and a second touch screen, such as the mobile computing device 10 described above. However, it will be appreciated that the method 5000 may be implemented on any other computing device that is equipped with at least one capacitive touch screen and suitable computer hardware. The method 5000 may be executed by a processor included in the mobile computing device, for example.

At step 5002, the method 5000 may include recognizing an engagement action of a digit on a virtual object displayed by a source application program on one of the first or second capacitive touch screens. As discussed above the engagement action may be an input gesture from a digit of the user on the first or second capacitive touch screens, such as a long press or a hard press, for example.

Continuing from step 5002 to step 5004, the method 5000 may include in response to the recognized engagement action, lifting the virtual object.

Proceeding from step 5004 to step 5006, the method 5000 may include recognizing a dragging action of the digit with the virtual object as the user moves the digit that is engaged with the first or second capacitive touch screens at a location of the virtual object.

Advancing from step 5006 to step 5008, the method 5000 may include moving the virtual object according to the dragging action to a pin location on one of the first or second touch screens. As described above, the virtual object is moved to the pin location on the first capacitive touch screen during the drag and drop operation 500.

Continuing from step 5008 to step 5010, the method 5000 may include recognizing a disengagement action of the digit from the virtual object. As described above, the user may lift the digit to indicate a disengagement action when the virtual object is at the pin location on the first capacitive touch screen.

Proceeding from step 5010 to step 5012, the method 5000 may include dropping the virtual object at the pin location to pin the virtual object to the pin location. According to the drag and drop operation 500, dropping the virtual object at the pin location on the first capacitive touch screen results in the pinning of the virtual object to the pin location on the first capacitive touch screen, as indicated at step 5014 of the method 5000.

In some implementations, the engagement action may occur on one of the first or second capacitive touch screens, and the pin location to which the virtual object is pinned may be a corner of the other of the first or second capacitive touch screens. In other implementations, the engagement action may occur on one of the first or second capacitive touch screens, and the pin location to which the virtual object is pinned may be a corner of the same capacitive touch screen.

As described above, once the virtual object is pinned at the pin location, subsequent drag and drop operations may be performed to insert or share the virtual object to the target destination. Additionally or alternatively, changing the orientation or configuration of the first and second capacitive touch screens by rotating them about the hinge may move the pinned virtual object to another pin location. It will be appreciated that the first and second capacitive touch screens may be configured to include multiple pin locations.

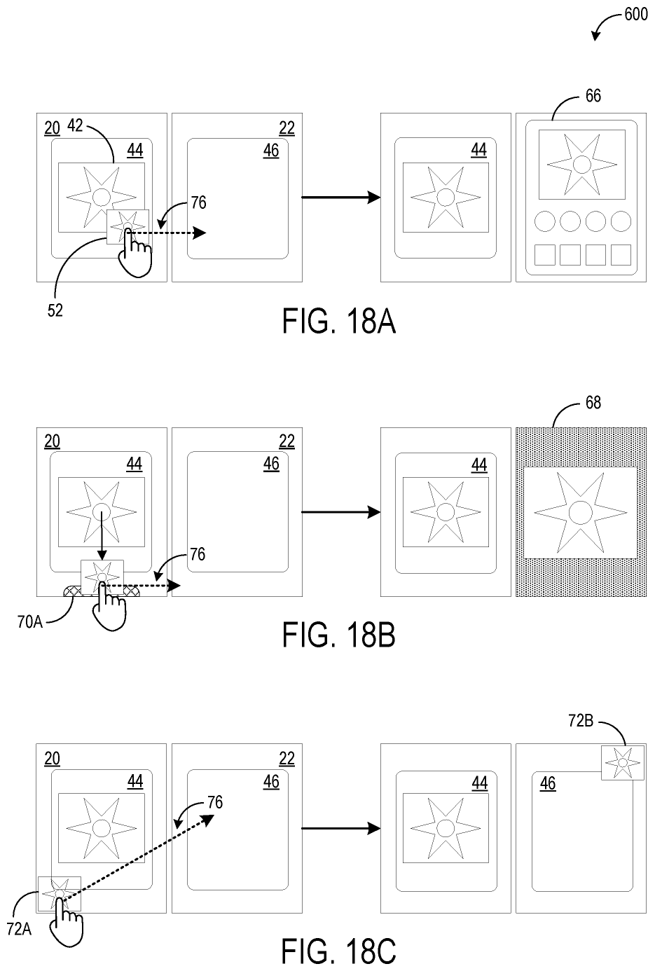

FIGS. 18A-18C schematically show an example of a flicking operation 600 in which a virtual object 42 is flicked to a target destination. In some use case scenarios, it may be desirable to reduce the dexterity required for performing a share drag and drop operation such as drag and drop operations 200, 300 described above, or to perform the share drag and drop operation in as short a time as possible. Flicking the thumbnail 52 of the virtual object 42 with a short, quick movement of the user's digit 50 enables a user to share the virtual object 42 to the operating system 62 or the target application program 46 without the need to drag the thumbnail 52 to the affordance icon 58. The location of the virtual object 42 and the location of the target destination may determine how the virtual object 42 is shared. For example, when the virtual object 42 is displayed by a source application program 44 on one of the first or second capacitive touch screens 20, 22 prior to the engagement action 48, flicking the virtual object 42 in a direction of a target application program 46 displayed on the other of the first or second capacitive touch screens 20, 22 may share the virtual object 42 to the target application program 46, similar to the drag and drop operation 200 described above. Likewise, flicking the virtual object 42 in a direction of an affordance icon 58 displayed on the same capacitive touch screen as the source application program 44 may share the virtual object 42 to the operating system 62, similar to the drag and drop operation 300 described above.

As shown in the example flicking operation 600 illustrated in FIG. 18A, the virtual object 42 may be displayed on the first capacitive touch screen 20 of the mobile computing device 10. As described above, the processor 34 may recognize the engagement action 48 and lift the thumbnail 52 representing the virtual object 42 from the source application program 44 on the first capacitive touch screen 20. When the thumbnail 52 is quickly moved in short, swift motion toward a specified direction, the processor 34 may be configured to recognize a flicking action 76.

In the example illustrated in FIG. 18A, the flicking action 76 (indicated by the dashed arrow) is in the direction of target application program 46 displayed on the second capacitive touch screen 22. In response to recognizing the flicking action 76 in the direction of the target application program 46, the processor may be configured to share the virtual object 42 to the target application program 46, similar to the end result of the drag and drop operation 300 described above.

When the first and second capacitive touch screens 20, 22 are arranged in the side-by-side orientation in which both screens are in a portrait configuration, flicking the thumbnail 52 in a rightward direction toward the target application program 46 displayed on the second capacitive touch screen 22 will share the virtual object 42 to the target application program 46, as described above in the drag and drop operation 300 and shown in FIG. 18A. Additionally, flicking the thumbnail 52 in an upward direction toward the affordance icon 58 will share the virtual object 42 to the operating system 62, as described above in the drag and drop operation 200.

Alternatively, when the first and second capacitive touch screens 20, 22 are arranged in the side-by-side orientation in which both screens are in a landscape configuration, flicking the thumbnail 52 in the upward direction toward the target application program 46 displayed on the second capacitive touch screen 22 will share the virtual object 42 to the target application program 46, as described above, and flicking the thumbnail 52 in a leftward direction toward the affordance icon 58 will share the virtual object 42 to the operating system 62.

Flicking may also enable a user to open the virtual object 42 in a new instance of an application program, as shown in FIG. 18B. Similar to the drag and drop operation 400 described above, after lifting the virtual object 42 from the source application program 44 displayed on one of the first and second capacitive touch screens 20, 22, the processor 34 may recognize a dragging action of the digit 50 engaged with the virtual object 42 and move the virtual object 42 according to the dragging action to a drop location. Flicking the virtual object 42 in the direction of the other of the first and second capacitive touch screens 20, 22 may open the virtual object 42 in a new instance of an application program on the other of the first and second capacitive touch screens 20, 22.

In the example shown in FIG. 18B, the virtual object 42 is lifted from the source application program 44 on the first capacitive touch screen 20, dragged to the drop location 70A on the first capacitive touch screen 20, and then flicked in the direction of the target application program 46 displayed on the second capacitive touch screen 22. This flicking action 76 open the virtual object 42 in a new instance of the default application program 68.

As illustrated in FIG. 18C, flicking may also be utilized to move a pinned virtual object 42 to another pin location 72. When the virtual object 42 is pinned at a first outer corner of one of the first or second touch screens 20, 22, flicking the pinned virtual object 42 in a direction of one of a second, third, or fourth outer corner of the first or second touch screens 20, 22 pins the virtual object 42 to a pin location 72 at the one of the second, third, or fourth outer corners toward which the virtual object 42 was flicked.

In the example shown in FIG. 18C, the virtual object 42 is pinned at the pin location 72A on the lower outer corner of the first capacitive touch screen 20. Performing a flicking action 76 on the pinned virtual object 42 in the direction of the upper outer corner of the second capacitive touch screen 22 may cause the pinned virtual object 42 to move to the pin location 72B at the upper outer corner of the second capacitive touch screen 22. As described above, the flicking action 76 on a pinned virtual object 42 may move the pinned virtual object 42 from one pin location 72 to another pin location 72 according to the directionality of the flicking action 76. It will be appreciated that when the mobile computing device is in the single screen mode in which the first and second capacitive touch screens 20, 22 are in a back-to-back orientation, the pin location 72 may be at each of the four outer corners of the capacitive touch screen with which the user is engaged.

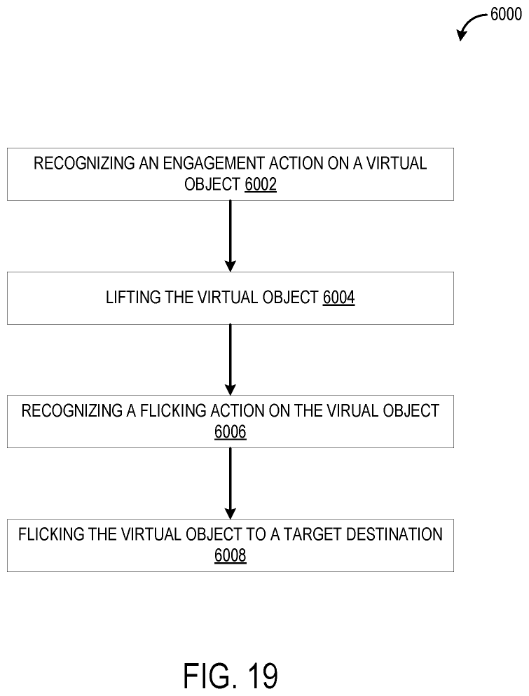

FIG. 19 shows an example method 6000 for the flicking operation 600 in which a virtual object is flicked to a target destination, according to one implementation of the present disclosure. Method 6000 is preferably implemented on a hinged mobile computing device having a first touch screen and a second touch screen, such as the mobile computing device 10 described above. However, it will be appreciated that the method 6000 may be implemented on any other computing device that is equipped with at least one capacitive touch screen and suitable computer hardware. The method 6000 may be executed by a processor included in the mobile computing device, for example.

At step 6002, the method 6000 may include recognizing an engagement action of a digit on a virtual object displayed on one of the first or second capacitive touch screens. As discussed above the engagement action may be an input gesture from a digit of the user on the first or second capacitive touch screens, such as a long press or a hard press, for example.

Continuing from step 6002 to step 6004, the method 6000 may include in response to the recognized engagement action, lifting the virtual object.

Proceeding from step 6004 to step 6006, the method 6000 may include recognizing a flicking action of the digit engaged with the virtual object. The flicking action may have a directionality, and may be recognized at the location of the virtual object as the user quickly moves the digit that is engaged with the first or second capacitive touch screens at a location of the virtual object.

Advancing from step 6006 to step 6008, the method 6000 may include flicking the virtual object to a target destination according to the directionality of the flicking action. The outcome of the flicking action may depend upon the target destination and/or the configuration of the first and second capacitive touch screens, as described in detail above.

In some embodiments, the methods and processes described herein may be tied to a computing system of one or more computing devices. In particular, such methods and processes may be implemented as a computer-application program or service, an application-programming interface (API), a library, and/or other computer-program product.

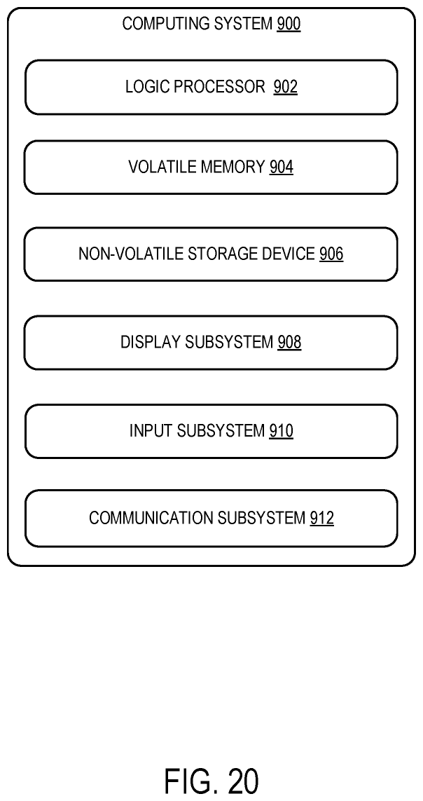

FIG. 20 schematically shows a non-limiting embodiment of a computing system 900 that can enact one or more of the methods and processes described above. Computing system 900 is shown in simplified form. Computing system 900 may embody the computer device 10 described above and illustrated in FIG. 2. Computing system 900 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 900 includes a logic processor 902 volatile memory 904, and a non-volatile storage device 906. Computing system 900 may optionally include a display subsystem 908, input subsystem 910, communication subsystem 912, and/or other components not shown in FIG. 20.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 906 includes one or more physical devices configured to hold instructions executable by the logic processors to implement the methods and processes described herein. When such methods and processes are implemented, the state of non-volatile storage device 906 may be transformed—e.g., to hold different data.

Non-volatile storage device 906 may include physical devices that are removable and/or built-in. Non-volatile storage device 906 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 906 may include nonvolatile, dynamic, static, read/write, read-only, sequential-access, location-addressable, file-addressable, and/or content-addressable devices. It will be appreciated that non-volatile storage device 906 is configured to hold instructions even when power is cut to the non-volatile storage device 906.

Volatile memory 904 may include physical devices that include random access memory. Volatile memory 904 is typically utilized by logic processor 902 to temporarily store information during processing of software instructions. It will be appreciated that volatile memory 904 typically does not continue to store instructions when power is cut to the volatile memory 904.

Aspects of logic processor 902, volatile memory 904, and non-volatile storage device 906 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 906, using portions of volatile memory 904. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 908 may be used to present a visual representation of data held by non-volatile storage device 906. The visual representation may take the form of a graphical user interface (GUI). As the herein described methods and processes change the data held by the non-volatile storage device, and thus transform the state of the non-volatile storage device, the state of display subsystem 908 may likewise be transformed to visually represent changes in the underlying data. Display subsystem 908 may include one or more display devices utilizing virtually any type of technology. Such display devices may be combined with logic processor 902, volatile memory 904, and/or non-volatile storage device 906 in a shared enclosure, or such display devices may be peripheral display devices.

When included, input subsystem 910 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 912 may be configured to communicatively couple various computing devices described herein with each other, and with other devices. Communication subsystem 912 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 900 to send and/or receive messages to and/or from other devices via a network such as the Internet.

The following paragraphs provide additional support for the claims of the subject application. One aspect provides a method for a drag and drop operation on a hinged mobile computing device having a first touch screen and a second touch screen. The method includes recognizing an engagement action of a digit on a virtual object displayed by a source application program on one of the first or second touch screens, lifting the virtual object in response to the recognized engagement action, recognizing a dragging action of the digit with the virtual object, moving the virtual object according to the dragging action to a target destination on an other of the first or second touch screens, recognizing a disengagement action of the digit from the virtual object, and dropping the virtual object at the target destination.

In this aspect, additionally or alternatively, the target destination may be within an open window of a target application program, and dropping the virtual object in the open window of the target application program inserts the virtual object at a determined location within the open window of the target application program. In this aspect, additionally or alternatively, the method may further include, prior to dropping the virtual object at the target destination, displaying a preview of the virtual object as it would appear after insertion into the target application. In this aspect, additionally or alternatively, the target destination may be an affordance icon of a target application program, and dropping the virtual object at the affordance icon of the target application program may share the virtual object to the target application program. In this aspect, additionally or alternatively, the method may further include, presenting the virtual object in a graphical user interface of the target application program. In this aspect, additionally or alternatively, the target destination may be a drop region located along an edge of the first or second touch screen, and dropping the virtual object at the drop region may open the virtual object in a new instance of a default application program. In this aspect, additionally or alternatively, the new instance of the application program may be displayed on a same touch screen of the first and second touch screens as the drop region at which the virtual object was dropped. In this aspect, additionally or alternatively, the virtual object may be depicted by a thumbnail during the dragging action, and an informational icon indicating an outcome of the drag and drop operation may be displayed adjacent the thumbnail.

Another aspect provides a method for a drag and drop operation on a hinged mobile computing device having a first touch screen and a second touch screen. The method includes recognizing an engagement action of a digit on a virtual object displayed by a source application program on one of the first or second touch screens, lifting the virtual object in response to the recognized engagement action, recognizing a dragging action of the digit engaged with the virtual object, moving the virtual object according to the dragging action to a pin location on one of the first or second touch screens, recognizing a disengagement action of the digit from the virtual object, and dropping the virtual object at the pin location to pin the virtual object to the pin location.

In this aspect, additionally or alternatively, the engagement action may occur on one of the first or second touch screens, and the pin location to which the virtual object is pinned may be a corner of an other of the first or second touch screens. In this aspect, additionally or alternatively, the engagement action may occur on one of the first or second touch screens, and the pin location to which the virtual object is pinned may be a corner of a same touch screen. In this aspect, additionally or alternatively, the virtual object may be depicted by a thumbnail during the dragging action, and the pinned virtual object may be displayed as the thumbnail. In this aspect, additionally or alternatively, the pin location may be a temporary location for the virtual object, and the method may further include performing a subsequent drag and drop operation on the pinned virtual object to move the virtual object to a target destination. In this aspect, additionally or alternatively, the drag and drop operation may be performed on one of the first or second touch screens when the computing device is in a single screen mode in which the first and second touch screens are in a back-to-back orientation, and the method may further include opening the mobile computing device to enable a double screen mode in which the first and second touch screens are in a side-by-side orientation, and performing a subsequent drag and drop operation on the pinned virtual object to move the virtual object from the pin location on one of the first or second touch screens to a target destination on an other of the first or second touch screens.

Another aspect provides a method for a flicking operation on a hinged mobile computing device having a first touch screen and a second touch screen. The method includes recognizing an engagement action of a digit on a virtual object displayed on one of the first or second touch screens, lifting the virtual object in response to the recognized engagement action, recognizing a flicking action of the digit engaged with the virtual object, the flicking action having a directionality, and flicking the virtual object to a target destination according to the directionality of the flicking action.

In this aspect, additionally or alternatively, prior to the engagement action, the virtual object may be displayed by a source application program on one of the first or second touch screens, and flicking the virtual object in a direction of a target application program displayed on an other of the first or second touch screens may share the virtual object to the target application program. In this aspect, additionally or alternatively, prior to the engagement action, the virtual object may be displayed by a source application program on one of the first or second touch screens, and flicking the virtual object in a direction of an affordance icon displayed on a same touch screen may share the virtual object to an operating system. In this aspect, additionally or alternatively, the method may further include, after lifting the virtual object, recognizing a dragging action of the digit engaged with the virtual object and moving the virtual object according to the dragging action to a drop location on a same touch screen, and flicking the virtual object in a direction of an other of the first and second touch screens may open the virtual object in a new instance of an application program on the other of the first and second touch screens. In this aspect, additionally or alternatively, the virtual object may be depicted by a thumbnail during the dragging action. In this aspect, additionally or alternatively, the virtual object may be pinned at a first outer corner of one of the first or second touch screens, and flicking the pinned virtual object in a direction of one of a second, third, or fourth outer corner of the first or second touch screens may pin the virtual object to the one of the second, third, or fourth outer corners toward which the virtual object was flicked.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for a hinged mobile computing device having a first touch screen and a second touch screen hinged to each other, the method comprising:
recognizing an engagement action of a digit on a virtual object displayed by a source application program on one of the first or second touch screens;
recognizing a dragging or flicking action of the digit with the virtual object following the recognized engagement action;
moving the virtual object according to the dragging or flicking action to a target destination on the first or second touch screens;
responsive to the target destination being a first location, performing a first action with respect to the virtual object in a default application program, the default application being selected by the computing device based on a feature of the virtual object or a user preset; and
responsive to the target destination being a second location that differs from the first location, performing a second action with respect to the virtual object that differs from the first action.

2. The method according to claim 1, wherein
the target destination is within an open window of a target application program as the second location; and
the second action includes inserting the virtual object at a determined location within the open window of the target application program following moving the virtual object to the target destination.

3. The method according to claim 2, the method further comprising:
following the engagement action and prior to the virtual object moving to the target destination, displaying a preview of the virtual object as it would appear inserted into the target application.

4. The method according to claim 1, wherein
the target destination is an affordance icon, the affordance icon being the first location; and
the first action includes sharing the virtual object to the default application program following moving the virtual object to the affordance icon.

5. The method according to claim 4, the method further comprising:
presenting the virtual object in a graphical user interface of the default application program.

6. The method according to claim 1, wherein
the target destination is a drop region located along an edge of the first or second touch screen, the drop region being the first location; and
the first action includes opening the virtual object in a new instance of the default application program following moving the virtual object to the drop region.

7. The method for a mobile computing device according to claim 6, wherein
the new instance of the default application program is displayed on a same touch screen of the first and second touch screens as the drop region.

8. The method according to claim 1, wherein
the dragging action of the digit with the virtual object is recognized;
the virtual object is depicted by a thumbnail during the dragging action; and
an informational icon indicating an outcome of a drag and drop operation to the target destination is displayed adjacent the thumbnail.

9. (canceled)

10. The method according to claim 21, wherein
the pin location to which the virtual object is pinned is a corner of an other of the first or second touch screens from where the engagement action occurred.

11. The method according to claim 21, wherein
the pin location to which the virtual object is pinned is a corner of a same touch screen where the engagement action occurred.

12. The method according to claim 21, wherein
the virtual object is depicted by a thumbnail during the dragging or flicking action; and
the virtual object is displayed as the thumbnail while pinned at the pin location.

13. The method according to claim 21, wherein
the pin location is a temporary location for the virtual object; and
the method further comprises, responsive to recognizing a subsequent dragging or flicking action on the virtual object pinned at the pin location, moving the virtual object to a subsequent target destination.

14. The method according to claim 21, wherein
the dragging or flicking action is performed on the one of the first or second touch screens when the computing device is in a single screen mode in which the first and second touch screens are in a back-to-back orientation; and the method further comprises:
initiating a double screen mode in which the first and second touch screens are in a side-by-side orientation responsive to the mobile computing device being opened by rotation of the first and second touch screens relative to each other, and
responsive to recognizing a subsequent dragging or flicking action on the virtual object pinned at the pin location, moving the virtual object from the pin location on the one of the first or second touch screens to a subsequent target destination on an other of the first or second touch screens.

15. (canceled)

16. The method according to claim 1, wherein
the flicking action of the digit with the virtual object is recognized;
prior to the engagement action, the virtual object is displayed by the source application program on the one of the first or second touch screens;
the target destination is a graphical feature of a target application program displayed on an other of the first or second touch screens as the second location; and
the second action includes sharing the virtual object to the target application program responsive to the flicking action being in a direction of the target application program.

17. The method according to claim 1, wherein
the flicking action of the digit with the virtual object is recognized;
prior to the engagement action, the virtual object is displayed by the source application program on the one of the first or second touch screens;
the target destination is an affordance icon displayed on the one of the first or second touch screens as the second location; and
the second action includes sharing the virtual object to an operating system responsive to the flicking action being in a direction of the affordance icon.

18. (canceled)

19. (canceled)

20. The method according to claim 21, wherein the pin location is at a first outer corner of one of the first or second touch screens; and
the method further comprises:
recognizing a subsequent flicking action on the virtual object pinned at the pin location in a direction of an other outer corner of the first or second touch screens having the first outer corner; and
pinning the virtual object to an other pin location at the other outer corner responsive to recognizing the subsequent flicking action being in the direction of the other outer corner.

21. The method of claim 1, wherein
the target destination is a pin location as the second location; and
the second action includes pinning the virtual object to the pin location.

22. The method of claim 1, wherein the dragging action of the digit with the virtual object is recognized; and
wherein the method further comprises:
lifting the virtual object in response to the recognized engagement action;
recognizing a disengagement of the digit from the virtual object following moving the virtual object according to the dragging action to the target destination, the target destination being on an other of the first or second touch screens from the one of the first or second touch screens on which the engagement action was recognized; and
dropping the virtual object at the target destination;
wherein the first action or the second action is performed following the dropping of the virtual object at the target destination.

23. The method of claim 1, wherein the flicking action of the digit with the virtual object is recognized;
wherein the second location is on an other of the first and second touch screens from the one of the first or second touch screens on which the engagement action was recognized; and
wherein the second action includes opening the virtual object in a new instance of the source application program on the other of the first and second touch screens responsive to the flicking action being toward the other of the first and second touch screens.

24. A hinged mobile computing device, comprising:
a first touch screen;
a second touch screen hinged to the first touch screen;
one or more processor devices; and
one or more storage devices having instructions stored thereon executable by the one or more processor devices to:
recognize an engagement action of a digit on a virtual object displayed by a source application program on one of the first or second touch screens;
recognize a dragging or flicking action of the digit with the virtual object following the recognized engagement action;
move the virtual object according to the dragging or flicking action to a target destination on the first or second touch screens;
responsive to the target destination being a first location, perform a first action with respect to the virtual object in a default application program, the default application being selected by the computing device based on a feature of the virtual object or a user preset; and
responsive to the target destination being a second location that differs from the first location, perform a second action with respect to the virtual object that differs from the first action.
